(19) United States
(12) Patent Application Publication
(10) Pub. No.: US 2026/0273395 A1
(43) Pub. Date: Sep. 17, 2026

(54) INFORMATION PROCESSING APPARATUS, INFORMATION PROCESSING METHOD, AND PROGRAM

(71) Applicant: SONY GROUP CORPORATION, TOKYO (JP)

(72) Inventor: TAKESHI ITAGAKI, TOKYO (JP)

(21) Appl. No.: 19/473,554

(22) PCT Filed: Apr. 1, 2024
(86) PCT No.: PCT/JP2024/013447

§ 371 Date: Oct. 8, 2025

(30) Foreign Application Priority Data
Apr. 17, 2023 (JP) 2023-066927

(51) Int. Cl. A63F 13/285; A63F 13/355; A63F 13/358

(52) U.S. Cl. CPC A63F 13/285; A63F 13/355; A63F 13/358

(57) ABSTRACT

The present technology relates to an information processing apparatus, an information processing method, and a program capable of suppressing deterioration in quality of user experience due to quality of a transmission path for transmitting information corresponding to displacement information regardless of a type of processing performed on the basis of the displacement information. The transmission control unit of the client apparatus performs control such that displacement information indicating displacement of an operation button that is displaced in accordance with a user's operation and presents a force sensation to the user is transmitted to a server 13 via the transmission path. The control unit controls presentation of a force sensation by the operation button on the basis of the quality of the transmission path. The present technology can be applied to, for example, a game streaming system or the like including a client apparatus, a controller apparatus connected to the client apparatus in a wired or wireless manner, and a server connected to the client apparatus via the Internet or the like.

### TECHNICAL FIELD

The present technology relates to an information processing apparatus, an information processing method, and a program, and more particularly, to an information processing apparatus, an information processing method, and a program capable of suppressing deterioration in quality of user experience due to quality of a transmission path for transmitting information corresponding to displacement information regardless of a type of processing performed on the basis of the displacement information.

### BACKGROUND ART

Recently, game streaming services that enable play of games such as console games via the Internet have been put into practical use. Game streaming systems that provide game streaming services include, for example, a server on a cloud and a client apparatus connected to the Internet. The client apparatus is connected to the controller and transmits an operation signal indicating an operation of the controller by the user to the server. The server renders video and audio of the game on the basis of the operation signal, encodes the video and the audio, respectively, and transmits the encoded video and audio to the client apparatus. The client apparatus receives and decodes the encoded video and audio, and reproduces the video and audio obtained as a result.

In the game streaming system, since the server performs rendering or the like, the client apparatus only needs to perform input/output processing, and processing in the client apparatus can be simplified.

On the other hand, interactivity is required in the game streaming systems, and in a case where the delay time from the transmission of the operation signal to the reproduction of the video and audio is long, it is difficult for the user to perform appropriate play. Therefore, in general, game streaming systems are designed such that this delay time is shortened.

As a result, in a case where the state of the transmission path between the server and the client apparatus is poor or unstable, the risk of packet loss due to the state of the transmission path is higher than that of the video streaming service that can use many buffers. As a result, the operation signal may not be accurately transmitted from the client apparatus to the server. In this case, a discrepancy occurs between the video and audio of the game rendered by the server and the video and audio of the game expected by the user, and the quality of the user experience is deteriorated.

Therefore, in a cloud game system, a method of predicting a variation of a wireless communication path connecting a game server and a game terminal and selecting a game scenario according to a progress state of a game and the predicted variation of the wireless communication path has been devised (see, for example, Patent Document 1). With this method, the influence of the variation of the wireless communication path can be absorbed by the game scenario and hidden from the user, and the quality of the user experience in the cloud game can be improved.

### CITATION LIST

### Patent Document

Patent Document 1: WO 2022/118534 A

### SUMMARY OF THE INVENTION

### Problems to be Solved by the Invention

However, the method described in Patent Document 1 cannot improve the quality of the user experience in a game other than a game in which the server can change the game scenario in real time. Therefore, regardless of the type of processing such as a game performed on the basis of the displacement information indicating the displacement of the operation unit such as the controller operated by the user, there is a demand for provision of a method for suppressing a decrease in the quality of the user experience due to the quality of the transmission path for transmitting the information corresponding to the displacement information, but such a demand has not been sufficiently responded.

The present technology has been made in view of such a situation, and an object thereof is to suppress deterioration in quality of user experience due to quality of a transmission path for transmitting information corresponding to displacement information regardless of a type of processing performed on the basis of the displacement information.

### Solutions to Problems

An information processing apparatus or a program according to a first aspect of the present technology is an information processing apparatus or a program for causing a computer to function as the information processing apparatus, the information processing apparatus including: a transmission control unit that performs control such that displacement information that indicates displacement of an operation unit that is displaced according to an operation of a user and presents a force sensation to the user is transmitted to another information processing apparatus via a first transmission path; and a control unit that controls presentation of the force sensation by the operation unit on the basis of quality of the first transmission path.

An information processing method according to the first aspect of the present technology is an information processing method in which an information processing apparatus includes: a transmission control step of performing control such that displacement information that indicates displacement of an operation unit that is displaced according to an operation of a user and presents a force sensation to the user is transmitted to another information processing apparatus via a first transmission path; and a control step of controlling presentation of the force sensation by the operation unit on the basis of quality of the first transmission path.

In the first aspect of the present technology, control is performed such that displacement information that indicates displacement of an operation unit that is displaced according to an operation of a user and presents a force sensation to the user is transmitted to another information processing apparatus via a first transmission path, and presentation of the force sensation by the operation unit is controlled on the basis of quality of the first transmission path.

An information processing apparatus or a program according to a second aspect of the present technology is an information processing apparatus or a program for causing a computer to function as the information processing apparatus, the information processing apparatus including: a reception control unit that controls reception of displacement information that is transmitted from another information processing apparatus via a transmission path and indicates displacement of an operation unit that is displaced in accordance with an operation of a user, and presents a force sensation to the user; a complementing unit that complements the displacement information received under control of the reception control unit; and a processing unit that performs processing on the basis of the displacement information complemented by the complementing unit, in which in a case where a state in which quality of the transmission path is a predetermined quality continues for a predetermined time or more, the complementing unit performs complementation by changing the displacement information received under the control of the reception control unit to displacement information indicating displacement of the operation unit to an initial position.

An information processing method according to the second aspect of the present technology is an information processing method in which an information processing apparatus includes: a reception control step of controlling reception of displacement information that is transmitted from another information processing apparatus via a transmission path and indicates displacement of an operation unit that is displaced in accordance with an operation of a user, and presents a force sensation to the user; a complementing step of complementing the displacement information received under control of the reception control step; and a processing step of performing processing on the basis of the displacement information complemented by the processing of the complementing step, in which in processing of the complementing step, in a case where a state in which quality of the transmission path is a predetermined quality continues for a predetermined time or more, complementation is performed by changing the displacement information received under the control of the reception control step to displacement information indicating displacement of the operation unit to an initial position.

In the second aspect of the present technology, reception of displacement information that is transmitted from another information processing apparatus via a transmission path and indicates displacement of an operation unit that is displaced according to an operation of a user and presents a force sensation to the user is controlled, the received displacement information is complemented, and processing is performed on the basis of the complemented displacement information. Note that, in a case where a state in which the quality of the transmission path is a predetermined quality continues for a predetermined time or more, the received displacement information is complemented by being changed to displacement information indicating displacement of the operation unit to the initial position.

An information processing apparatus or a program according to a third aspect of the present technology is an information processing apparatus or a program for causing a computer to function as the information processing apparatus, the information processing apparatus including: a communication control unit that performs control such that position information that indicates a position of an operation unit that is displaced according to an operation of a user and presents a force sensation to the user is transmitted to another first information processing apparatus via a first transmission path; and a control unit that controls presentation of the force sensation by the operation unit on the basis of quality of the first transmission path and quality of a second transmission path between the another first information processing apparatus and another second information processing apparatus, in which the another first information processing apparatus transmits displacement information indicating displacement generated on the basis of the position information to the another second information processing apparatus via the second transmission path.

An information processing method according to the third aspect of the present technology is an information processing method in which an information processing apparatus includes: a communication control step of performing control such that position information that indicates a position of an operation unit that is displaced according to an operation of a user and presents a force sensation to the user is transmitted to another first information processing apparatus via a first transmission path; and a control step of controlling presentation of the force sensation by the operation unit on the basis of quality of the first transmission path and quality of a second transmission path between the another first information processing apparatus and another second information processing apparatus, in which the another first information processing apparatus transmits displacement information indicating displacement generated on the basis of the position information to the another second information processing apparatus via the second transmission path.

In the third aspect of the present technology, control is performed such that position information indicating a position of an operation unit that is displaced according to an operation of a user and presents a force sensation to the user is transmitted to another first information processing apparatus via a first transmission path, presentation of the force sensation by the operation unit is controlled on the basis of quality of the first transmission path and quality of a second transmission path between the another first information processing apparatus and another second information processing apparatus, and the another first information processing apparatus transmits displacement information indicating the displacement generated on the basis of the position information to the another second information processing apparatus via the second transmission path.

### BRIEF DESCRIPTION OF DRAWINGS

FIG. 1 is a diagram illustrating an overview of a first embodiment of a game streaming system to which the present technology is applied.

FIG. 2 is a block diagram illustrating a configuration example of a game streaming system in FIG. 1.

FIG. 3 is a graph illustrating an example of a relationship between an actual displacement of an operation button and a displacement of an operation button reflected in a game in a case where transmission path force sensation information is not generated.

FIG. 4 is a graph illustrating a first example of a relationship between an actual displacement of an operation button and a displacement of an operation button reflected in a game in the game streaming system.

FIG. 5 is a graph illustrating an example of a relationship between an actual displacement of an operation button and a displacement of an operation button reflected in a game in a case where transmission path force sensation information is not generated and displacement information is not complemented.

FIG. 6 is a graph illustrating a second example of a relationship between an actual displacement of an operation button and a displacement of an operation button reflected in a game in the game streaming system.

FIG. 7 is a flowchart for explaining gaming session processing in the first embodiment.

FIG. 8 is a flowchart for explaining details of session establishment processing in FIG. 7.

FIG. 9 is a flowchart for explaining inter-server estimation processing.

FIG. 10 is a flowchart for explaining control processing in the first embodiment.

FIG. 11 is a flowchart for explaining complementing processing.

FIG. 12 is a block diagram illustrating a configuration example of a second embodiment of a game streaming system to which the present technology is applied.

FIG. 13 is a flowchart for explaining gaming session processing in the second embodiment.

FIG. 14 is a flowchart for explaining control processing in the second embodiment.

FIG. 15 is a flowchart for explaining details of multi-control processing in FIG. 14.

FIG. 16 is a flowchart for explaining request processing.

FIG. 17 is a block diagram illustrating a configuration example of a third embodiment of a game streaming system to which the present technology is applied.

FIG. 18 is a flowchart for explaining inter-controller estimation processing.

FIG. 19 is a flowchart for explaining overall control processing.

FIG. 20 is a block diagram illustrating a configuration example of hardware of a computer.

### MODE FOR CARRYING OUT THE INVENTION

Modes for carrying out the present technology (hereinafter, referred to as embodiments) will be described below. Note that the description will be given in the following order.

1. First Embodiment (Game Streaming System in Which Game Is Performed Using One Client Apparatus)

2. Second Embodiment (Game Streaming System in Which Game Is Performed Using Plurality of Client Apparatuses)

3. Third Embodiment (Game Streaming System for Controlling Force Sensation and Tactile Sensation Based on Quality of Transmission Path Between Controller Apparatus and Client Apparatus)

4. Computer

### 1. First Embodiment

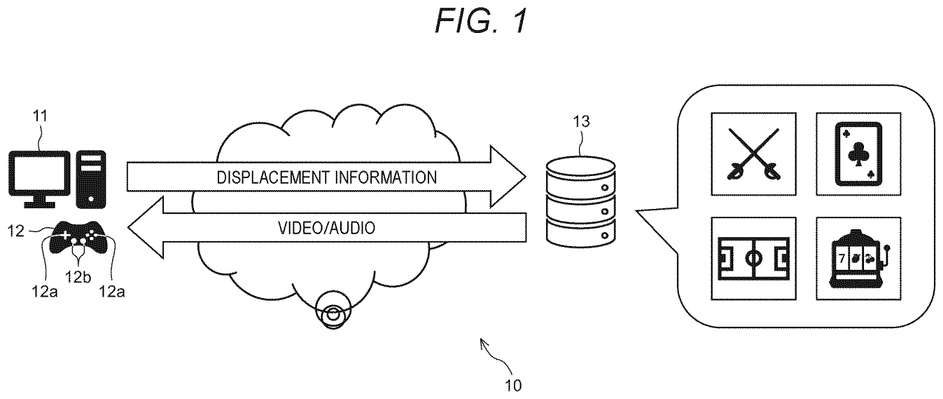

FIG. 1 is a diagram illustrating an overview of a first embodiment of a game streaming system to which the present technology is applied.

The game streaming system 10 in FIG. 1 includes a client apparatus 11, a controller apparatus 12, and a server 13.

The client apparatus 11 is an information processing apparatus that is connected to the controller apparatus 12 in a wired or wireless manner and is connected to the server 13 via a network such as the Internet.

The client apparatus 11 receives the position information indicating the position of the operation button 12a or the joystick 12b of the controller apparatus 12 transmitted from the controller apparatus 12. Note that the operation button 12a is a generic term of one or more operation buttons provided in the controller apparatus 12, and the joystick 12b is a generic term of one or more joysticks provided in the controller apparatus 12.

The client apparatus 11 transmits displacement information indicating displacement of the operation button 12a or the joystick 12b to the server 13 via a network transmission path on the basis of the position information. The client apparatus 11 receives and decodes the video and audio of the encoded game transmitted from the server 13 on the basis of the displacement information. The client apparatus 11 reproduces video and audio obtained as a result of decoding.

The client apparatus 11 transmits, to the controller apparatus 12, force sensation information for controlling presentation of a force sensation by the operation button 12a or the joystick 12b on the basis of the quality of the transmission path to and from the server 13.

The controller apparatus 12 is an information processing apparatus connected to the client apparatus 11 in a wired or wireless manner. The controller apparatus 12 includes an operation button 12a and a joystick 12b as operation units that are displaced in accordance with a user's operation and present a force sensation to the user. The controller apparatus 12 transmits the position information of the operation button 12a and the joystick 12b to the client apparatus 11. The controller apparatus 12 receives the force sensation information transmitted from the client apparatus 11. The controller apparatus 12 causes the operation button 12a and the joystick 12b to present a force sensation on the basis of the force sensation information.

The server 13 is an information processing apparatus connected to the client apparatus 11 via a network such as the Internet. The server 13 receives the displacement information transmitted from the controller apparatus 12 via the transmission path. The server 13 executes a game (game content) on the basis of the displacement information, and renders video and audio of the game. The server 13 encodes the video and audio and transmits the encoded video and audio to the client apparatus 11 via the transmission path.

### <Configuration Example of Game Streaming System>

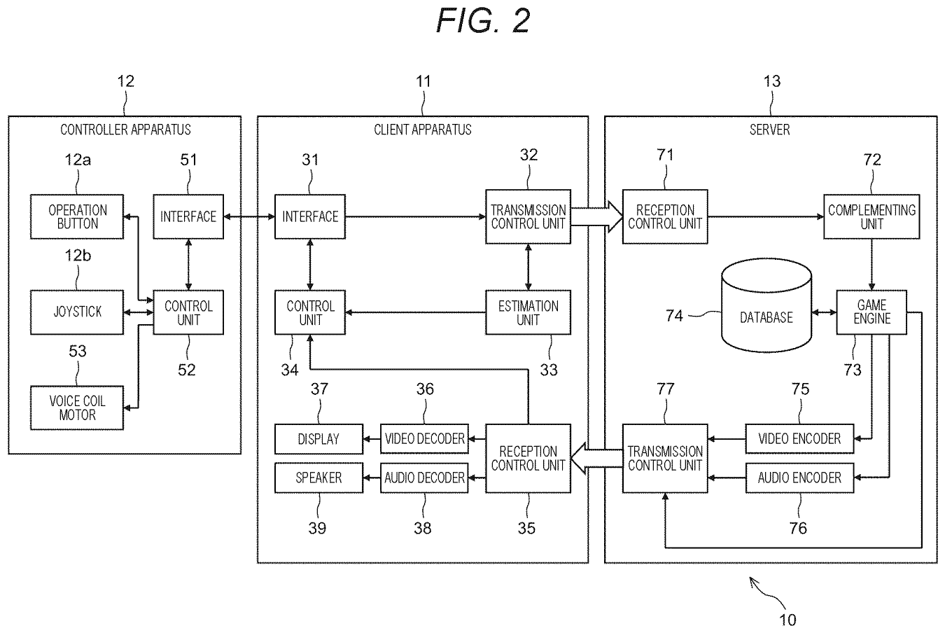

FIG. 2 is a block diagram illustrating a configuration example of the game streaming system 10 in FIG. 1.

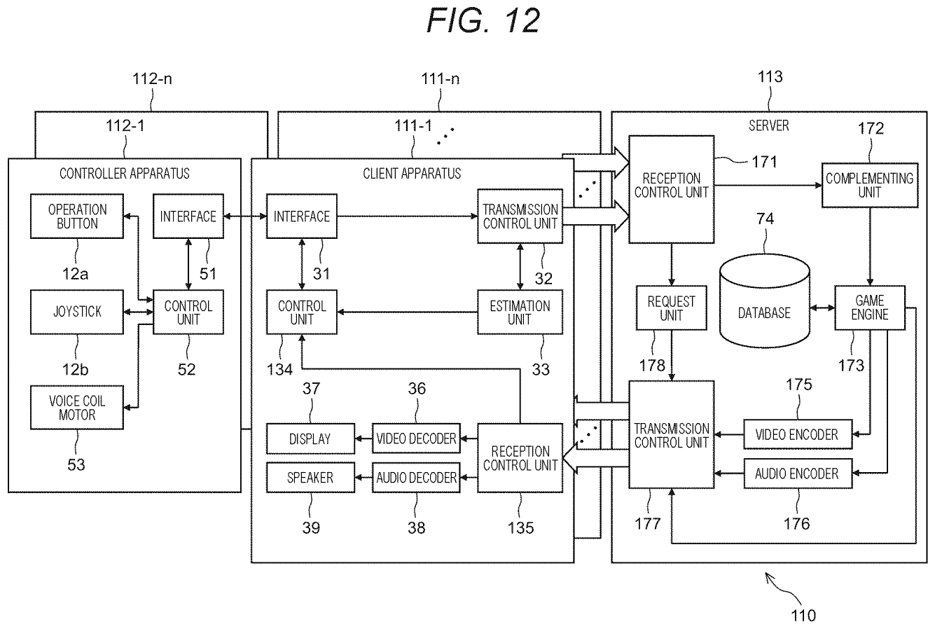

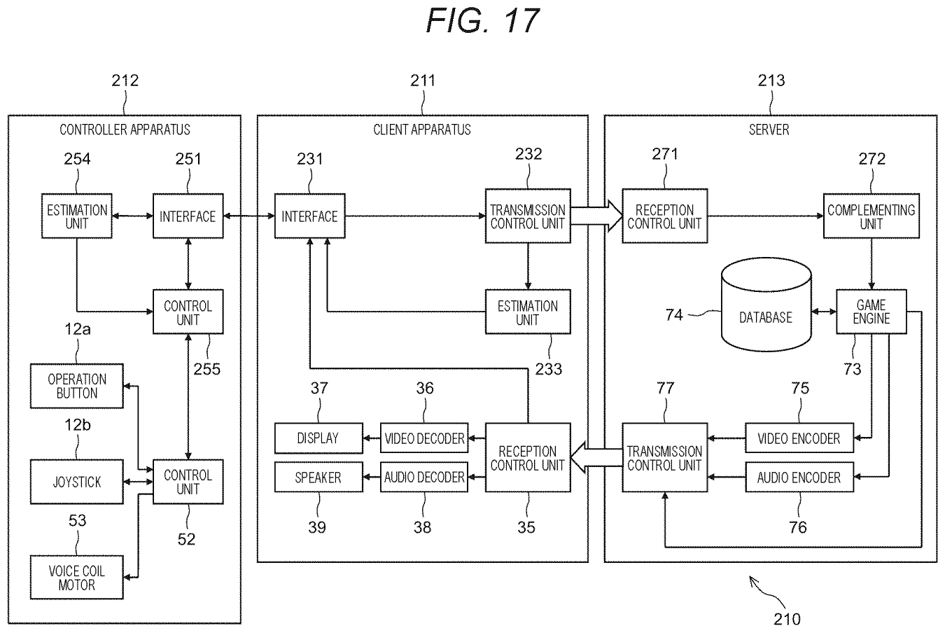

Note that outlined arrows in FIG. 2 indicate network links. It similarly applies to FIGS. 12 and 17 described later.

The client apparatus 11 includes an interface 31, a transmission control unit 32, an estimation unit 33, a control unit 34, a reception control unit 35, a video decoder 36, a display 37, an audio decoder 38, and a speaker 39.

The interface 31 includes, for example, a universal serial bus (USB), a network interface, a Bluetooth (registered trademark) interface, and the like. The interface 31 controls transmission and reception of information to and from the controller apparatus 12.

Specifically, the interface 31 controls reception of the position information transmitted from the controller apparatus 12, and supplies the position information to the transmission control unit 32 and the control unit 34. The interface 31 controls transmission of force sensation information supplied from the control unit 34 and tactile sensation information for controlling presentation of tactile sensation by the controller apparatus 12 to the controller apparatus 12.

In a case where the position information supplied from the interface 31 changes, the transmission control unit 32 generates displacement information indicating a displacement from the position indicated by the position information before the change to the position indicated by the position information after the change. The transmission control unit 32 packetizes the displacement information and the inter-server quality information indicating the quality of the transmission path between the client apparatus 11 and the server 13 supplied from the estimation unit 33. The transmission control unit 32 performs addition of a header of each communication layer, protocol processing, and the like on the resultant packet to generate a transmission packet. The transmission control unit 32 performs control such that the transmission packet is transmitted to the server 13 via the transmission path.

The estimation unit 33 collects various metrics of the transmission path between the client apparatus 11 and the server 13 via the transmission control unit 32. Examples of the metric include a packet loss rate, round trip time, and the number of transmission/reception bytes. In a case where the transmission path is a wireless link, the metric may be a retransmission rate of a data link layer, a transmission rate of a physical layer, received radio wave intensity, or the like.

The estimation unit 33 periodically estimates the quality of the transmission path on the basis of the collected metric. For example, the estimation unit 33 predicts, on the basis of the metric, a risk that the packet loss rate in the transmission path between the client apparatus 11 and the server 13 will be equal to or more than a certain level in the near future, and estimates the risk as the quality of the transmission path. The estimation unit 33 generates information indicating the risk numerically as inter-server quality information, and supplies the generated information to the transmission control unit 32 and the control unit 34. Note that any method can be used as a method of estimating the quality of the transmission path by the estimation unit 33.

The control unit 34 generates transmission path force sensation information, which is force sensation information based on the quality of the transmission path, on the basis of the position information supplied from the interface 31 and the inter-server quality information supplied from the estimation unit 33. As a result, the control unit 34 controls presentation of a force sensation by the operation button 12a or the joystick 12b on the basis of the inter-server quality information. The control unit 34 generates final force sensation information on the basis of the transmission path force sensation information and game force sensation information that is force sensation information corresponding to a scene of a game supplied from the reception control unit 35, and supplies the final force sensation information to the interface 31.

The control unit 34 generates transmission path tactile sensation information that is tactile sensation information based on the quality of the transmission path on the basis of the inter-server quality information supplied from the estimation unit 33. As a result, the control unit 34 controls presentation of tactile sensation by the controller apparatus 12 on the basis of the inter-server quality information. The control unit 34 generates final tactile sensation information on the basis of the transmission path tactile sensation information and the game tactile sensation information that is the tactile sensation information corresponding to the scenario of the game supplied from the reception control unit 35, and supplies the final tactile sensation information to the interface 31.

The reception control unit 35 controls reception of a transmission packet transmitted from the server 13 via the transmission path. The reception control unit 35 performs protocol processing or the like on the transmission packet received by this control, and analyzes the content of the payload. The reception control unit 35 supplies the game force sensation information and the game tactile sensation information included as payloads in the transmission packet to the control unit 34 on the basis of the analysis result. On the basis of the analysis result, the reception control unit 35 supplies the encoded video included in the transmission packet as a payload to the video decoder 36, and supplies the encoded audio to the audio decoder 38.

Note that, in a case where the meta information is added to the video (audio) included in the transmission packet, the meta information is also supplied to the video decoder 36 (audio decoder 38) together with the video (audio), and is used in the video decoder 36 (audio decoder 38), for example.

The video decoder 36 decodes the encoded video supplied from the reception control unit 35, and supplies (the digital data of) the video obtained as a result to the display 37. The display 37 performs display on the basis of the video supplied from the video decoder 36.

The audio decoder 38 decodes the encoded audio supplied from the reception control unit 35, and supplies (digital data of) the audio obtained as a result to the speaker 39. The speaker 39 outputs audio on the basis of the audio supplied from the audio decoder 38.

The controller apparatus 12 includes an operation button 12a, a joystick 12b, an interface 51, a control unit 52, and a voice coil motor 53.

The operation button 12a is biased in the direction of the initial position by an elastic body or the like, and the position of the operation button 12a is the initial position in a case where no operation is performed by the user. When the user performs an operation of pressing with a finger or the like, the operation button 12a is displaced within a predetermined one-dimensional range. The operation button 12a functions as a sensor that acquires an electric signal indicating the current position, and supplies the electric signal to the control unit 52. The operation button 12a also functions as a device that presents a force sensation on the basis of an electric signal supplied from the control unit 52.

The joystick 12b is biased in the direction of the center position as the initial position by an elastic body or the like, and the position of the joystick 12b is the initial position in a case where no operation is performed by the user. When the user performs an operation to tilt the joystick 12b with a finger or the like, the joystick is displaced within a predetermined two-dimensional range. The joystick 12b functions as a sensor that acquires the current position as an electric signal, and supplies the electric signal to the control unit 52. The operation button 12a also functions as a device that presents a force sensation on the basis of an electric signal supplied from the control unit 52.

The interface 51 includes, for example, a USB, a network interface, a Bluetooth (registered trademark) interface, and the like. The interface 51 controls transmission and reception of information to and from the client apparatus 11. Specifically, the interface 51 performs control such that the position information supplied from the control unit 52 is transmitted to the client apparatus 11. The interface 51 controls reception of the force sensation information and the tactile sensation information transmitted from the client apparatus 11, and supplies the received force sensation information and tactile sensation information to the control unit 52.

The control unit 52 generates position information by converting electric signals supplied from the operation button 12a and the joystick 12b into digital information, and supplies the position information to the interface 51.

The control unit 52 generates an electric signal for performing control so as to present a force sensation corresponding to the force sensation information supplied from the interface 51, and supplies the electric signal to the operation button 12a or the joystick 12b that presents the force sensation. The control unit 52 generates an electric signal for performing control so as to present a tactile sensation corresponding to the tactile sensation information, and supplies the electric signal to the voice coil motor 53.

The voice coil motor 53 presents a tactile sensation of vibration to the user by generating vibration of a predetermined vibration waveform on the basis of the electric signal supplied from the control unit 52. The controller apparatus 12 may include a vibrator instead of the voice coil motor 53.

The server 13 includes a reception control unit 71, a complementing unit 72, a game engine 73, a database 74, a video encoder 75, an audio encoder 76, and a transmission control unit 77.

The reception control unit 71 controls reception of a transmission packet transmitted from the client apparatus 11 via the transmission path. The reception control unit 71 performs protocol processing or the like on the transmission packet received by this control, and analyzes the content of the payload. The reception control unit 71 supplies the displacement information and the inter-server quality information included in the transmission packet as a payload to the complementing unit 72 on the basis of the analysis result. Note that, in a case where the meta information is included in the received packet of the displacement information, the meta information is also supplied to the complementing unit 72.

The complementing unit 72 complements the displacement information on the basis of the inter-server quality information supplied from the reception control unit 71 and supplies the same to the game engine 73.

The game engine 73 (processing unit) executes a game stored in the database 74 on the basis of the displacement information supplied from the complementing unit 72. As a result, for example, the game engine 73 functions as a renderer that renders the video and audio of the game on the basis of the displacement information. Specifically, the game engine 73 reads an image, an object, background music (BGM), sound effects, and the like corresponding to a predetermined scene of the game from the database 74, and performs various types of processing to generate video and audio of the game. The game engine 73 also generates game force sensation information and game tactile sensation information corresponding to the scene.

The game engine 73 supplies the video of the game to the video encoder 75 and supplies the audio to the audio encoder 76. The game engine 73 supplies the game force sensation information and the game tactile sensation information to the transmission control unit 77.

The database 74 stores a game. The database 74 also stores images, objects, BGM, sound effects, and the like corresponding to each scene of the game.

The video encoder 75 encodes (compresses) the video supplied from the game engine 73 by a method suitable for a transmission path between the client apparatus 11 and the server 13, and supplies the video to the transmission control unit 77.

The audio encoder 76 encodes the audio supplied from the game engine 73 by a method suitable for a transmission path between the client apparatus 11 and the server 13, and supplies the encoded audio to the transmission control unit 77.

The transmission control unit 77 packetizes the game force sensation information and the game tactile sensation information supplied from the game engine 73, the encoded video supplied from the video encoder 75, and the encoded audio supplied from the audio encoder 76. The transmission control unit 77 performs addition of a header of each communication layer, protocol processing, and the like on the resultant packet to generate a transmission packet. The transmission control unit 77 performs control such that the transmission packet is transmitted to the client apparatus 11 via the transmission path.

Note that, in a case where the game engine 73 generates meta information of video and audio and supplies the meta information to the transmission control unit 77, the transmission control unit 77 adds the meta information to the video and audio at the time of packetizing the video and audio.

Hereinafter, in order to simplify the description, a case where the user operates the operation button 12a will be described, but it similarly applies to a case where the joystick 12b is operated except that position information, displacement information, and force sensation information are generated for each of the X direction and the Y direction. Note that the X direction and the Y direction are directions orthogonal to each other in which the joystick 12b can be displaced.

<Example of Relationship Between Actual Displacement of Operation Button and Displacement of Operation Button Reflected in Game in Case where Transmission Path Force Sensation Information is not Generated>

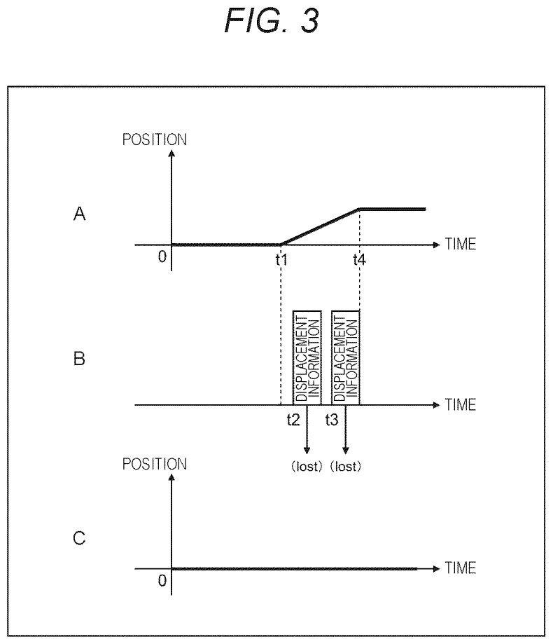

FIG. 3 is a graph illustrating an example of the relationship between the actual displacement of the operation button 12a and the displacement of the operation button 12a reflected in the game in a case where the transmission path force sensation information is not generated.

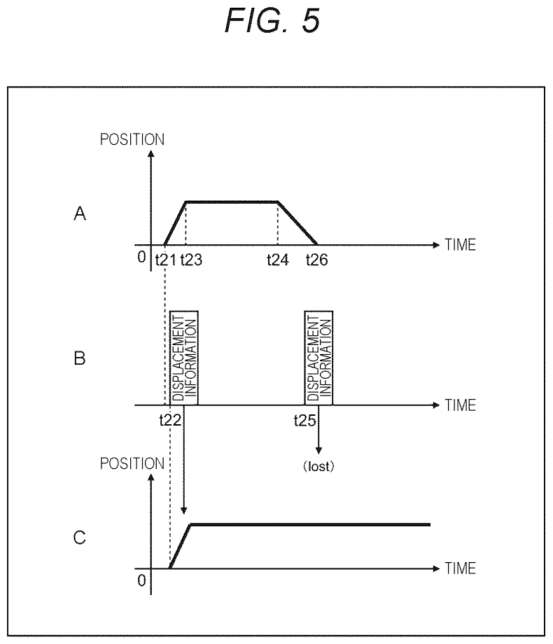

A of FIG. 3 is a graph illustrating a temporal change of the position of the operation button 12a indicated by the electric signal acquired by the operation button 12a. In A of FIG. 3, the vertical axis represents a position, and the horizontal axis represents time. B of FIG. 3 is a graph illustrating a transmission timing of a transmission packet under the control of the transmission control unit 32. The horizontal axis in B of FIG. 3 represents time, and the rectangle represents the content of the payload of the transmission packet transmitted at that time. C of FIG. 3 is a graph illustrating a temporal change of the position of the operation button 12a reflected in the game executed by the game engine 73. In C of FIG. 3, the vertical axis represents a position, and the horizontal axis represents time. The above similarly applies to A to C of FIG. 5. Note that, in the present specification, the initial position of the operation button 12a is represented by 0.

In the example of FIG. 3, as illustrated in A of FIG. 3, the position of the operation button 12a starts to be displaced from the initial position by the user's operation at time t1. As a result, as illustrated in B of FIG. 3, at time t2 (t1≤t2), the transmission control unit 32 performs control so that a transmission packet including displacement information indicating the displacement as a payload is transmitted to the server 13. However, in the example of FIG. 3, at this time, the quality of the transmission path between the client apparatus 11 and the server 13 is poor, and this transmission packet is lost. As a result, as illustrated in C of FIG. 3, the position of the operation button 12a reflected in the game remains at the initial position.

As illustrated in B of FIG. 3, also at time t3 (t2<t3), similarly to the case of time t2, the transmission control unit 32 performs control such that a transmission packet including the displacement information indicating the displacement indicated by A of FIG. 3 as a payload is transmitted to the server 13. However, in the example of FIG. 3, the quality of the transmission path is also poor at this time, and this transmission packet is also lost. As a result, as illustrated in C of FIG. 3, the position of the operation button 12a reflected in the game remains at the initial position.

When the position of the operation button 12a reaches the upper limit of the displaceable range at time t4 (t3<t4), the operation button 12a ends the displacement, and the position of the operation button 12a does not change as illustrated in A of FIG. 3. Therefore, the transmission control unit 32 stops the transmission of the transmission packet including the displacement information.

As described above, in a case where the quality of the transmission path between the client apparatus 11 and the server 13 is poor and the transmission packet including the displacement information is missing, the operation is not reflected in the game even though the user operates the operation button 12a. That is, the actual displacement of the operation button 12a is different from the displacement reflected in the game. As a result, the user feels uncomfortable and stressed.

### <First Example of Relationship Between Actual Displacement of Operation Button and Displacement of Operation Button Reflected in Game in Game Streaming System>

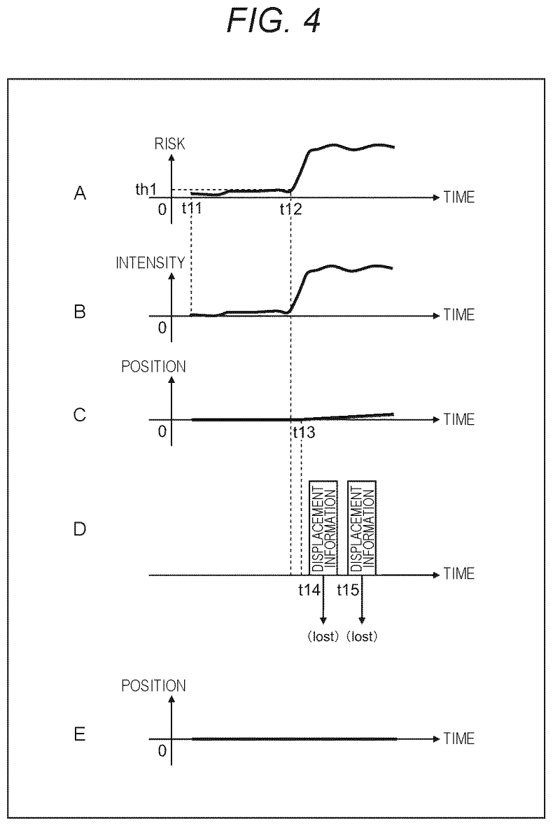

FIG. 4 is a graph illustrating a first example of the relationship between the actual displacement of the operation button 12a and the displacement of the operation button 12a reflected in the game in the game streaming system 10.

A of FIG. 4 is a graph illustrating a temporal change of a risk indicated by the inter-server quality information. In A of FIG. 4, the vertical axis represents risk, and the horizontal axis represents time. B of FIG. 4 is a graph illustrating a temporal change in intensity of presentation of a displacement suppression force sensation that is a force sensation for suppressing displacement of the operation button 12a based on transmission path force sensation information. In B of FIG. 4, the vertical axis represents intensity, and the horizontal axis represents time. The graphs of C to E of FIG. 4 are similar to the graphs of A to C of FIG. 3, respectively.

In the example of FIG. 4, as illustrated in A of FIG. 4, the risk indicated by the inter-server quality information from time t11 to time t12 (t11<t12) is lower than the threshold value th1, but rises to exceed the threshold value th1 at time t12. Therefore, at time t12, the control unit 34 starts generating, on the basis of the inter-server quality information, transmission path force sensation information for performing control so as to present a displacement suppression force sensation of intensity according to the risk represented by the inter-server quality information.

As a result, as illustrated in B of FIG. 4, at time t12, the intensity of the displacement suppression force sensation presented by the operation button 12a increases on the basis of the transmission path force sensation information. This makes it difficult for the user to operate and displace the operation button 12a. Therefore, even if the user starts operating the operation button 12a at time t13 (t12≤t13), the change in the position of the operation button 12a is small as illustrated in C of FIG. 4.

Note that, specifically, the displacement suppression force sensation is a sense of a reaction force against the pressing force to the operation button 12a. In the example of FIG. 4, the intensity corresponding to the risk indicated by the inter-server quality information is proportional to the risk, but may be obtained by performing nonlinear conversion on the risk.

When the position of the operation button 12a is displaced at time t13, as illustrated in D of FIG. 4, at time t14 (t13≤t14), the transmission control unit 32 performs control so that a transmission packet including displacement information indicating the displacement as a payload is transmitted to the server 13. However, since the risk indicated by the inter-server quality information at time t12 exceeds the threshold value th1, this transmission packet is lost in the example of FIG. 4. As a result, as illustrated in E of FIG. 4, the position of the operation button 12a reflected in the game remains at the initial position.

As illustrated in D of FIG. 4, also at time t15 (t14<t15), similarly to the case of time t14, the transmission control unit 32 performs control such that a transmission packet including the displacement information indicating the displacement indicated by C of FIG. 4 as a payload is transmitted to the server 13. However, since the risk represented by the inter-server quality information still exceeds the threshold value th1 even at this time, this transmission packet is also lost in the example of FIG. 4. As a result, as illustrated in E of FIG. 4, the position of the operation button 12a reflected in the game remains at the initial position.

As described above, in a case where the quality of the transmission path between the client apparatus 11 and the server 13 is poor, the transmission packet including the displacement information is lost, and the displacement information is not reflected in the game. However, in the game streaming system 10, in a case where the risk represented by the inter-server quality information exceeds the threshold value th1, the operation button 12a presents the displacement suppression force sensation. Therefore, it is difficult for the user to operate and displace the operation button 12a. As a result, the difference between the actual displacement of the operation button 12a and the displacement reflected in the game decreases. As a result, it is possible to reduce the discomfort and stress of the user and improve the user experience as compared with the case of FIG. 3.

<Example of Relationship Between Actual Displacement of Operation Button and Displacement of Operation Button Reflected in Game in Case where Transmission Path Force Sensation Information is not Generated and Displacement Information is not Complemented>

FIG. 5 is a graph illustrating an example of the relationship between the actual displacement of the operation button 12a and the displacement of the operation button 12a reflected in the game in a case where the transmission path force sensation information is not generated and the displacement information is not complemented.

In the example of FIG. 5, as illustrated in A of FIG. 5, at time t21, the position of the operation button 12a starts to be displaced from the initial position by the user's operation. Accordingly, as illustrated in B of FIG. 5, at time t22 (t21≤t22), the transmission control unit 32 performs control such that a transmission packet including the displacement information indicating the displacement as a payload is transmitted to the server 13.

At this time, in the example of FIG. 5, the quality of the transmission path between the client apparatus 11 and the server 13 is good. Therefore, this transmission packet is received under the control of the reception control unit 71. As a result, as illustrated in C of FIG. 5, the displacement of the operation button 12a reflected in the game is the actual displacement of the operation button 12a.

When the position of the operation button 12a reaches the upper limit of the displaceable range at time t23 (t22<t23), the operation button 12a ends the displacement, and the position of the operation button 12a does not change as illustrated in A of FIG. 5. Therefore, the transmission control unit 32 stops the transmission of the transmission packet including the displacement information.

Thereafter, when the user releases the operation button 12a at time t24 (t23≤t24), the position of the operation button 12a starts to return to the initial position as illustrated in A of FIG. 5. As a result, as illustrated in B of FIG. 5, at time t25 (t24≤t25), the transmission control unit 32 performs control so that a transmission packet including displacement information indicating the displacement to the initial position as a payload is transmitted to the server 13. However, in the example of FIG. 5, at this time, the quality of the transmission path between the client apparatus 11 and the server 13 deteriorates, and this transmission packet is lost. As a result, as illustrated in C of FIG. 5, the position of the operation button 12a reflected in the game does not change.

As described above, in a case where the quality of the transmission path between the client apparatus 11 and the server 13 is poor and the transmission packet including the displacement information is missing, the user releases the operation button 12a, but the operation is not reflected in the game. As a result, the user feels uncomfortable and stressed.

### <Second Example of Relationship Between Actual Displacement of Operation Button and Displacement of Operation Button Reflected in Game in Game Streaming System>

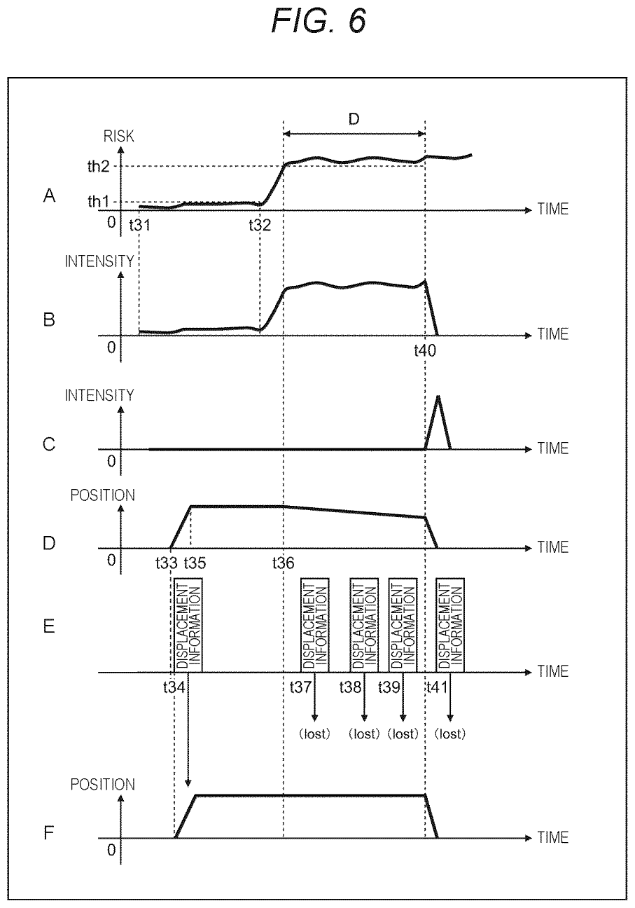

FIG. 6 is a graph illustrating a second example of the relationship between the actual displacement of the operation button 12a and the displacement of the operation button 12a reflected in the game in the game streaming system 10.

The graphs in A and B of FIG. 6 are similar to the graphs in A and B of FIG. 4, respectively. C of FIG. 6 is a graph illustrating a temporal change in intensity of presentation of an initial position force sensation, which is a force sensation with which the operation button 12a is displaced to the initial position, based on the transmission path force sensation information. In C of FIG. 6, the vertical axis represents intensity, and the horizontal axis represents time. The graphs of D to F of FIG. 6 are similar to the graphs of A to C of FIG. 3, respectively.

In the example of FIG. 6, as illustrated in A of FIG. 6, the risk indicated by the inter-server quality information from time t31 to time t32 (t31<t32) is low. Therefore, during this period, the control unit 34 does not generate the transmission path force sensation information. In the example of FIG. 6, at time t33 (t31≤t33≤t32) during this period, as illustrated in D of FIG. 6, the position of the operation button 12a starts to be displaced from the initial position by the user's operation. As a result, as illustrated in E of FIG. 6, at time t34 (t33≤t34≤t32), the transmission control unit 32 performs control so that a transmission packet including displacement information indicating the displacement as a payload is transmitted to the server 13.

At time t34, since the risk indicated by the inter-server quality information remains lower than the threshold value th1, this transmission packet is received under the control of the reception control unit 71. At this time, the complementing unit 72 supplies the displacement information included in the transmission packet to the game engine 73 as it is without complementing the displacement information. As a result, as illustrated in F of FIG. 6, the displacement of the operation button 12a reflected in the game executed by the game engine 73 is the actual displacement of the operation button 12a.

When the position of the operation button 12a reaches the upper limit of the displaceable range at time t35 (t33<t35<t32), the operation button 12a ends the displacement, and the position of the operation button 12a does not change as illustrated in D of FIG. 6. Therefore, the transmission control unit 32 stops the transmission of the transmission packet including the displacement information.

At time t32, when the risk represented by the inter-server quality information exceeds the threshold value th1, the control unit 34 starts generation of transmission path force sensation information for performing control so as to present a displacement suppression force sensation having an intensity corresponding to the risk. As a result, as illustrated in B of FIG. 6, at time t32, the intensity of the displacement suppression force sensation presented by the operation button 12a increases on the basis of the transmission path force sensation information. This makes it difficult for the user to operate and displace the operation button 12a.

Therefore, even in a case where the user releases the operation button 12a to return the operation button 12a to the initial position at time t36 (t32≤t36), the change in the position of the operation button 12a is small as illustrated in D of FIG. 6.

When the position of the operation button 12a is displaced at time t36, as illustrated in E of FIG. 6, at time t37 (t36≤t37), the transmission control unit 32 performs control so that a transmission packet including displacement information indicating the displacement as a payload is transmitted to the server 13. However, since the risk indicated by the inter-server quality information at time t32 exceeds the threshold value th1, this transmission packet is lost in the example of FIG. 6. As a result, as illustrated in F of FIG. 6, the position of the operation button 12a reflected in the game remains at the position based on the displacement information received at the time t34.

As illustrated in D of FIG. 6, also at times t38 to t39 (t37<t38<t39), similarly to the case of time t37, the transmission control unit 32 performs control such that the transmission packet including the displacement information indicating the displacement indicated by D of FIG. 6 is transmitted to the server 13. However, also at this time, since the risk represented by the inter-server quality information exceeds the threshold value th1, in the example of FIG. 6, this transmission packet is lost. As a result, as illustrated in F of FIG. 6, the position of the operation button 12a reflected in the game remains at the position based on the displacement information received at the time t34.

As described above, in the game streaming system 10, in a case where the risk represented by the inter-server quality information exceeds the threshold value th1, the operation button 12a presents the displacement suppression force sensation. Therefore, it is difficult for the user to operate and displace the operation button 12a. As a result, even in a case where the transmission packet including the displacement information is lost, the difference between the actual displacement of the operation button 12a and the displacement reflected in the game becomes small. As a result, the discomfort and stress of the user can be reduced and the user experience can be improved as compared with the case of FIG. 5.

However, in a case where the position of the operation button 12a is other than the initial position, if a state in which the operation button cannot be returned to the initial position continues for a long time, a sense of discomfort or stress is given to the user. Therefore, the control unit 34 generates transmission path force sensation information for performing control so as to present an initial position force sensation.

Specifically, in the example of FIG. 6, after the risk represented by the inter-server quality information exceeds the threshold value th1 at time t32, the risk becomes equal to or greater than the threshold value th2 (th2≥th1) at time t36. In a case where a state in which the risk represented by the inter-server quality information is equal to or greater than the threshold value th2 is continued for a timeout period D or more, the control unit 34 generates transmission path force sensation information for performing control so as to present an initial position force sensation.

As a result, as illustrated in C of FIG. 6, at time t40 (t39≤t40) after a lapse of the timeout period D from time t36, the intensity of the initial position force sensation presented by the operation button 12a increases on the basis of the transmission path force sensation information. On the other hand, as illustrated in B of FIG. 6, the intensity of the displacement suppression force sensation presented by the operation button 12a decreases. As described above, as illustrated in D of FIG. 6, the position of the operation button 12a starts to return to the initial position.

At time t41 (t40≤t41), the transmission control unit 32 performs control such that a transmission packet including displacement information indicating the displacement to the initial position as a payload is transmitted to the server 13. However, since the risk represented by the inter-server quality information exceeds the threshold value th1, this transmission packet is lost in the example of FIG. 6.

On the other hand, at a time t40 after a lapse of the timeout period D from the time t36, the complementing unit 72 complements the displacement information received at the time t34 by changing the displacement information to the displacement information indicating the displacement to the initial position, and supplies the complemented displacement information to the game engine 73. As a result, as illustrated in F of FIG. 6, the displacement of the operation button 12a reflected in the game executed by the game engine 73 becomes the displacement to the initial position and becomes the same as the actual displacement of the operation button 12a.

As described above, in a case where the state in which the quality of the transmission path between the client apparatus 11 and the server 13 is poor continues for the timeout period D or more and the position of the operation button 12a is a position other than the initial position, the operation button 12a presents the initial position force sensation. As a result, it is possible to reduce the user's uncomfortable feeling and stress caused by the state in which it is not possible to return to the initial position continuing for a long time.

Furthermore, in this case, the displacement of the operation button 12a reflected in the game is changed to the displacement to the initial position. As a result, the difference between the actual displacement of the operation button 12a and the displacement reflected in the game decreases. As a result, discomfort and stress of the user can be reduced, and user experience can be improved.

### <Description of Gaming Session Processing>

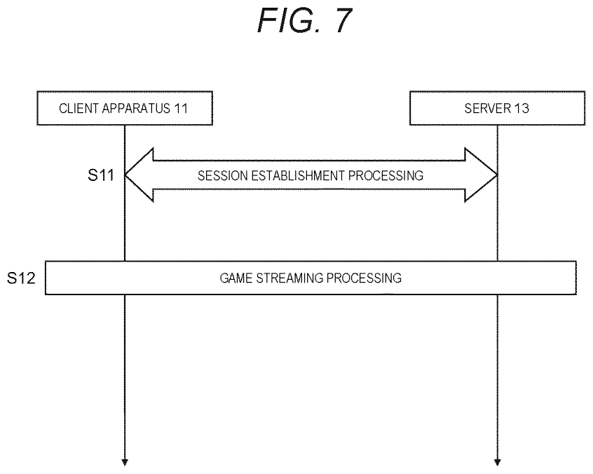

FIG. 7 is a flowchart for explaining gaming session processing by the client apparatus 11 and the server 13.

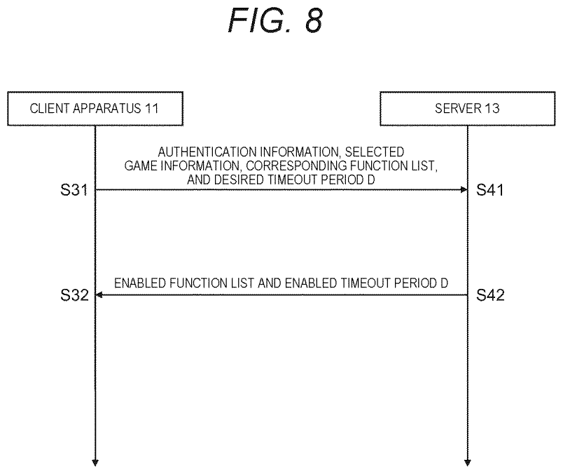

In step S11 of FIG. 7, the client apparatus 11 and the server 13 perform session establishment processing for establishing a session as preparation processing of game streaming processing in step S12 to be described later. Details of the session establishment processing will be described with reference to FIG. 8 described later.

In step S12, the client apparatus 11 and the server 13 perform game streaming processing. In this game streaming processing, the client apparatus 11 transmits the displacement information to the server 13, and the server 13 executes the game on the basis of the displacement information to generate video and audio of the game, encodes the video and audio, and transmits the encoded video and audio to the client apparatus 11. As a result, the video of the game is displayed on the display 37, and the audio of the game is output from the speaker 39. After the processing in step S12, the session ends, and the gaming session processing ends.

### <Description of Session Establishment Processing>

FIG. 8 is a flowchart for explaining details of the session establishment processing in step S11 of FIG. 7.

In step S31 of FIG. 8, the transmission control unit 32 of the client apparatus 11 is connected to the server 13 via the network, and performs control such that the authentication information, the selected game information, the corresponding function list, and the desired timeout period D are transmitted to the server 13.

The selected game information is information indicating a game selected by the user. The corresponding function list is a list of functions included in the client apparatus 11. Note that the desired number of timeout periods D may be one or more. Furthermore, the client apparatus 11 may transmit a desired range of the timeout period D to the server 13 instead of the desired timeout period D itself.

In step S41, the reception control unit 71 of the server 13 controls the reception of the authentication information, the selected game information, the corresponding function list, and the desired timeout period D transmitted by the processing in step S31. The reception control unit 71 collates the functions registered in the corresponding function list with the functions of the server 13 to determine functions to be actually enabled in the game streaming processing, and generates a list of the functions as an enabled function list. The reception control unit 71 enables the predetermined timeout period D on the basis of the desired timeout period D. The reception control unit 71 supplies the enabled timeout period D to the complementing unit 72.

In step S42, the transmission control unit 77 controls the enabled function list and the enabled timeout period D to be transmitted to the client apparatus 11.

In step S32, the reception control unit 35 controls reception of the enabled function list and the enabled timeout period D transmitted by the processing in step S42. As a result, the timeout period D is shared between the client apparatus 11 and the server 13.

Note that the session establishment processing in FIG. 8 is performed by one round trip transmission and reception between the client apparatus 11 and the server 13, but may be performed by being divided into a plurality of round trip transmission and reception.

### <Description of Inter-Server Estimation Processing>

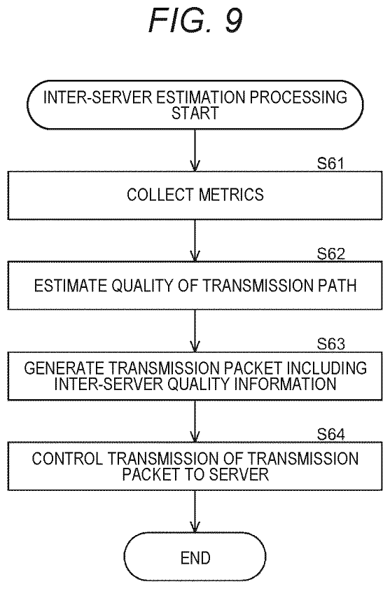

FIG. 9 is a flowchart for explaining inter-server estimation processing for estimating the quality of the transmission path between the client apparatus 11 and the server 13 performed by the client apparatus 11 in the game streaming processing in step S12 in FIG. 7. This inter-server estimation processing is performed periodically, for example.

In step S61 of FIG. 9, the estimation unit 33 collects various metrics of the transmission path between the client apparatus 11 and the server 13 via the transmission control unit 32. In step S62, the estimation unit 33 estimates the quality of the transmission path on the basis of the metric collected in step S61, and generates the inter-server quality information. The estimation unit 33 supplies the inter-server quality information to the transmission control unit 32 and the control unit 34.

In step S63, the transmission control unit 32 packetizes the inter-server quality information supplied from the estimation unit 33, and generates a transmission packet including the inter-server quality information as a payload. In step S64, the transmission control unit 32 controls transmission of the transmission packet generated in step S63 to the server 13. Then, the inter-server estimation processing ends.

### <Description of Control Processing>

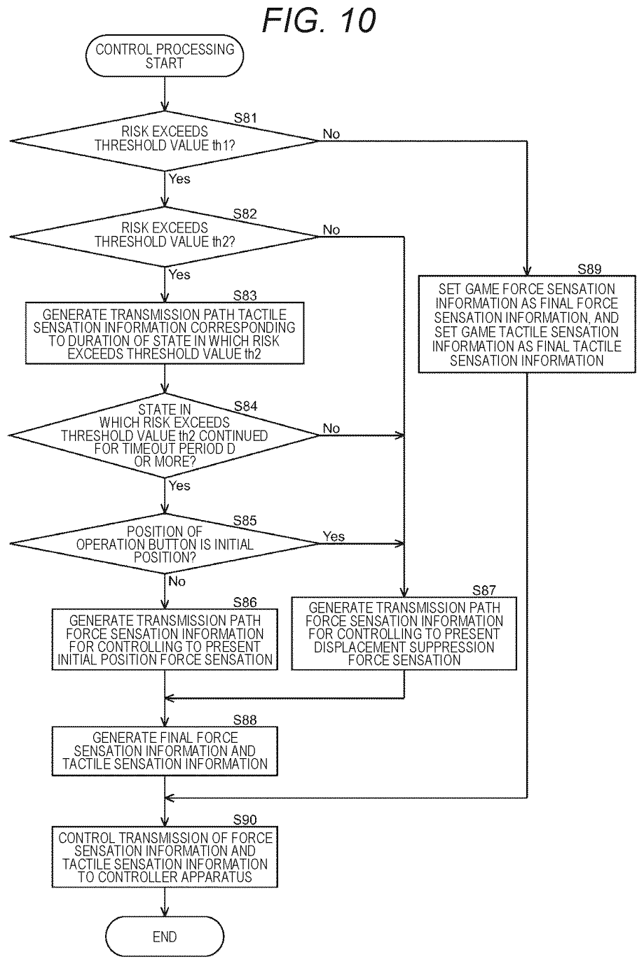

FIG. 10 is a flowchart for explaining control processing for controlling presentation of a force sensation and a tactile sensation on the basis of the inter-server quality information, which is performed by the client apparatus 11 in the game streaming processing in step S12 in FIG. 7. This control processing is started, for example, when new inter-server quality information is supplied from the estimation unit 33 to the control unit 34, or when new game force sensation information or game tactile sensation information received from the server 13 under the control of the reception control unit 35 is supplied to the control unit 34.

Note that, in the example of FIG. 10, it is assumed that the first inter-server estimation processing of FIG. 9 is performed before the control processing of FIG. 10.

In step S81 of FIG. 10, the control unit 34 determines whether or not the risk represented by the inter-server quality information supplied from the estimation unit 33 exceeds the threshold value th1. In a case where it is determined in step S81 that the risk exceeds the threshold value th1, the processing proceeds to step S82.

In step S82, the control unit 34 determines whether or not the risk represented by the inter-server quality information exceeds the threshold value th2. In a case where it is determined in step S82 that the risk exceeds the threshold value th2, the processing proceeds to step S83.

In step S83, the control unit 34 generates transmission path tactile sensation information corresponding to the duration of the state in which the risk represented by the inter-server quality information exceeds the threshold value th2. For example, in a case where the duration is equal to or longer than a predetermined time, the control unit 34 generates transmission path tactile sensation information for performing control so as to present a tactile sensation corresponding to the duration in order to explicitly notify the user that the state of the transmission path is poor. Note that the tactile sensation according to the duration is a tactile sensation of intensity according to the duration, a tactile sensation continuing for a time according to the duration, or the like.

In step S84, the control unit 34 determines whether or not a state in which the risk represented by the inter-server quality information exceeds the threshold value th2 has continued for the timeout period D or more. In a case where it is determined in step S84 that the state in which the risk exceeds the threshold value th2 continues for the timeout period D or more, the processing proceeds to step S85.

In step S85, the control unit 34 determines whether or not the position of the operation button 12a is the initial position on the basis of the position information supplied from the interface 31. In a case where it is determined in step S85 that the position of the operation button 12a is not the initial position, the processing proceeds to step S86.

In step S86, the control unit 34 generates transmission path force sensation information for performing control so as to present an initial position force sensation. Then, the processing proceeds to step S88.

On the other hand, in a case where it is determined in step S82 that the risk does not exceed the threshold value th2, or in a case where it is determined in step S84 that a state where the risk exceeds the threshold value th2 has not yet continued for the timeout period D or more, the processing proceeds to step S87.

In step S87, the control unit 34 generates transmission path force sensation information for performing control so as to present a displacement suppression force sensation having an intensity corresponding to the risk represented by the inter-server quality information. Then, the processing proceeds to step S88.

In step S88, the control unit 34 generates final force sensation information and tactile sensation information. Specifically, the control unit 34 combines the game force sensation information supplied from the reception control unit 35 with the transmission path force sensation information generated in step S86 or step S87 to generate final force sensation information. In a case where the transmission path tactile sensation information is generated in step S83, the control unit 34 combines the transmission path tactile sensation information and the game tactile sensation information supplied from the reception control unit 35 to generate the final tactile sensation information. In a case where the transmission path tactile sensation information has not been generated in step S83, the control unit 34 generates the game tactile sensation information supplied from the reception control unit 35 as the final tactile sensation information. The control unit supplies the final force sensation information and tactile sensation information to the interface 31. Then, the processing proceeds to step S90.

On the other hand, in a case where it is determined in step S81 that the risk does not exceed the threshold value th1, the processing proceeds to step S89. In step S89, the control unit 34 sets the game force sensation information supplied from the reception control unit 35 as the final force sensation information and supplies the game tactile sensation information to the interface 31 as the final tactile sensation information. Then, the processing proceeds to step S90.

In step S90, the interface 31 controls transmission of the force sensation information and the tactile sensation information supplied from the control unit 34 to the controller apparatus 12. As a result, the operation button 12a presents a force sensation based on the force sensation information, and the voice coil motor 53 presents a tactile sensation based on the tactile sensation information. After the processing of step S90, the control processing ends.

Note that, in a case where the first inter-server estimation processing is not performed before the control processing of FIG. 10, the game force sensation information and the game tactile sensation information received from the server 13 are transmitted to the controller apparatus 12 as the final force sensation information and tactile sensation information until the first inter-server estimation processing is performed.

The control unit 34 may transmit at least one of the changed force sensation information or tactile sensation information to the controller apparatus 12 via the interface 31 only in a case where at least one of the final force sensation information or the tactile sensation information has changed.

As described above, the control unit 34 combines the transmission path force sensation information with the game force sensation information to generate the final force sensation information. Therefore, it is possible to cause the user to illusion the force sensation based on the transmission path force sensation information with the force sensation corresponding to the scene of the game. As a result, it is possible to obtain an effect of further reducing the stress of the user. This effect is greater at the time of execution of a game that frequently uses presentation of force sensation.

### <Description of Complementing Processing>

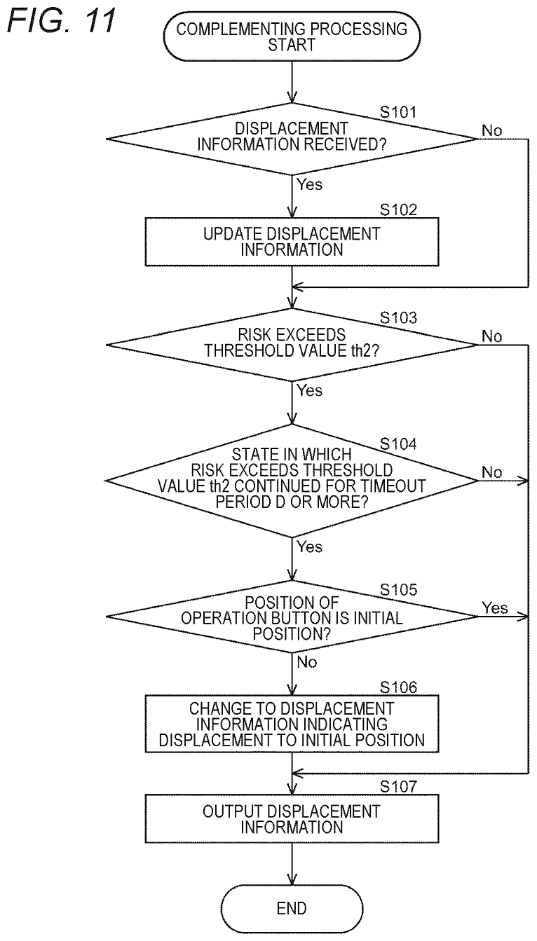

FIG. 11 is a flowchart for explaining the complementing processing for complementing the displacement information, which is performed by the server 13 in the game streaming processing in step S12 in FIG. 7. This complementing processing is started, for example, when a transmission packet including new displacement information or inter-server quality information is received from the client apparatus 11 under the control of the reception control unit 71.

In step S101 of FIG. 11, the reception control unit 71 determines whether or not a transmission packet including the displacement information as a payload is received from the client apparatus 11. In a case where it is determined in step S101 that the transmission packet including the displacement information is received, the reception control unit 71 supplies the displacement information to the complementing unit 72 and advances the processing to step S102.

In step S102, the complementing unit 72 updates the displacement information on the basis of the displacement information supplied from the reception control unit 71. Specifically, the complementing unit 72 sets the displacement information supplied from the reception control unit 71 as the current displacement information. Then, the processing proceeds to step S103.

On the other hand, in a case where it is determined in step S101 that the transmission packet including the displacement information is not received, the processing proceeds to step S103.

In step S103, the complementing unit 72 determines whether or not the risk indicated by the inter-server quality information supplied from the reception control unit 71 exceeds the threshold value th2. In a case where it is determined in step S103 that the risk exceeds the threshold value th2, the processing proceeds to step S104.

In step S104, the complementing unit 72 determines whether or not a state in which the risk indicated by the inter-server quality information exceeds the threshold value th2 has continued for the timeout period D or more. In a case where it is determined in step S103 that the state in which the risk exceeds the threshold value th2 is continued for the timeout period D or more, the processing proceeds to step S105.

In step S105, the complementing unit 72 determines whether or not the position of the operation button 12a is the initial position on the basis of the current displacement information. In a case where it is determined in step S105 that the position of the operation button 12a is not the initial position, the processing proceeds to step S106.

In step S106, the complementing unit 72 complements the current displacement information by changing the current displacement information to the displacement information indicating the displacement to the initial position, and the processing proceeds to step S107.

On the other hand, in a case where it is determined in step S103 that the risk does not exceed the threshold value th2, or in a case where it is determined in step S104 that a state where the risk exceeds the threshold value th2 has not yet continued for the timeout period D or more, the processing proceeds to step S107. In a case where it is determined in step S105 that the position of the operation button 12a is the initial position, the processing proceeds to step S107.

In step S107, the complementing unit 72 outputs the current displacement information to the game engine 73. Then, the complementing processing ends.

As described above, in the complementing processing of FIG. 11, in a case where the state in which the risk exceeds the threshold value th2 is continued for the timeout period D or more and the position of the operation button 12a is not the initial position, the complementing unit 72 changes the information to the displacement information indicating the displacement to the initial position. On the other hand, in this case, in the control processing of FIG. 9, the control unit 34 generates the initial position force sensation information as described above.

As a result, the difference between the displacement of the operation button 12a indicated by the displacement information output to the game engine 73 by the complementing processing and the displacement of the operation button 12a by the force sensation presented on the basis of the final force sensation information generated by the control processing is reduced. Specifically, the client apparatus 11 and the server 13 can recognize the release of the operation button 12a at substantially the same time.

Note that the state in which the risk exceeds the threshold value th2 in steps S103 and S104 may be another state such as a state in which the transmission packet including the inter-server quality information is not periodically received as long as the quality of the transmission path is equal to or less than the predetermined quality. The control processing of FIG. 10 and the complementing processing of FIG. 11 are performed asynchronously.

As described above, the transmission control unit 32 of the client apparatus 11 controls the displacement information to be transmitted to the server 13 via the transmission path, and the control unit 34 controls the presentation of the force sensation by the operation button 12a on the basis of the inter-server quality information.

For example, the control unit 34 performs control such that the operation button 12a presents a displacement suppression force sensation in a case where the risk represented by the inter-server quality information exceeds the threshold value th1. As a result, even in a case where the state of the transmission path for transmitting the displacement information is poor and the displacement information is missing, the difference between the actual displacement of the operation button 12a and the displacement of the operation button 12a reflected in the game becomes small. As a result, regardless of the type of game or the like performed by the server 13 on the basis of the displacement information, it is possible to suppress deterioration in the quality of the user experience such as discomfort or stress of the user caused by lack of the displacement information due to the quality of the transmission path for transmitting the displacement information.

For example, the control unit 34 performs control such that the operation button 12a presents an initial position force sensation in a case where a state in which the risk represented by the inter-server quality information exceeds the threshold value th2 continues for a timeout period D or more. As a result, in a case where the state in which the risk exceeds the threshold value th2 continues for the timeout period D or more, the position of the operation button 12a returns to the initial position. As a result, it is possible to prevent deterioration in quality of the user experience such as discomfort and stress of the user caused by the long-term suppression of the displacement of the operation button 12a to the initial position by the displacement suppression force sensation.

The reception control unit 71 of the server 13 controls reception of the displacement information transmitted from the client apparatus 11 via the transmission path. In a case where the state in which the risk indicated by the inter-server quality information exceeds the threshold value th2 is continued for the timeout period D or more, the complementing unit 72 complements the displacement information by changing the displacement information to the displacement information indicating the displacement to the initial position. The game engine 73 executes a game on the basis of the displacement information complemented by the complementing unit 72.

As a result, even in a case where the state of the transmission path for transmitting the displacement information is poor and the displacement information indicating the displacement to the initial position by the user's operation or the initial position force sensation is missing, the difference between the actual displacement of the operation button 12a and the displacement of the operation button 12a reflected in the game becomes small. As a result, regardless of the type of game or the like performed by the server 13 on the basis of the displacement information, it is possible to suppress deterioration in the quality of the user experience such as discomfort or stress of the user caused by lack of the displacement information due to the quality of the transmission path for transmitting the displacement information.

Since the client apparatus 11 and the server 13 share the timeout period D, it is possible to minimize the deviation between the actual displacement of the operation button 12a and the displacement of the operation button 12a reflected in the game.

The control unit 34 performs control so that the voice coil motor 53 presents a tactile sensation according to the duration of a state in which the risk represented by the inter-server quality information exceeds the threshold value th2. As a result, the user can recognize that the quality of the transmission path is poor.

Note that the client apparatus 11 may not transmit the inter-server quality information to the server 13, and the server 13 itself may include an estimation unit similar to the estimation unit 33 and supply the inter-server quality information to the complementing unit 72.

### 2. Second Embodiment

### <Configuration Example of Game Streaming System>

FIG. 12 is a block diagram illustrating a configuration example of a second embodiment of a game streaming system to which the present technology is applied.

In the game streaming system 110 of FIG. 12, portions corresponding to those of the game streaming system 10 of FIG. 2 are denoted by the same reference signs. Therefore, description of the portion will be appropriately omitted, and description will be given focusing on a portion different from the game streaming system 10.

The game streaming system 110 includes n (n is a plurality of) client apparatuses 111-1 to 111-n, n controller apparatuses 112-1 to 112-n, and a server 113. Note that, in the following, in a case where it is not necessary to particularly distinguish the client apparatuses 111-1 to 111-n, they are collectively referred to as a client apparatus 111. Similarly, the controller apparatuses 112-1 to 112-n are collectively referred to as a controller apparatus 112.

In the game streaming system 110, the server 113 executes the same game for the n client apparatuses 111 connected thereto, and the n client apparatuses 111 generate the same transmission path force sensation information and transmission path tactile sensation information.

Specifically, the client apparatus 111 is different from the client apparatus 11 in that the control unit 34 and the reception control unit 35 are replaced with the control unit 134 and the reception control unit 135, respectively, and is configured similarly to the client apparatus 11 in the other respects.

The control unit 134 generates transmission path force sensation information on the basis of the position information supplied from the interface 31 and the inter-server quality information supplied from the estimation unit 33, or the force sensation control request supplied from the reception control unit 135. The force sensation control request is a request for generating transmission path force sensation information based on the inter-server quality information of the transmission path between each of the n client apparatuses 111 and the server 113 transmitted from the server 113. As described above, the control unit 134 controls presentation of a force sensation on the basis of the inter-server quality information and the position information between the own client apparatus 111 and the server 113, or the inter-server quality information of the transmission path between each of the n client apparatuses 111 and the server 113.

The control unit 134 generates final force sensation information on the basis of the transmission path force sensation information and the game force sensation information supplied from the reception control unit 135, and supplies the final force sensation information to the interface 31.

The control unit 134 generates transmission path tactile sensation information on the basis of the inter-server quality information supplied from the estimation unit 33 or the tactile sensation control request supplied from the reception control unit 135. The tactile sensation control request is a request for generating transmission path tactile sensation information based on the inter-server quality information of the transmission path between each of the n client apparatuses 111 and the server 113, transmitted from the server 113. As described above, the control unit 134 controls tactile presentation on the basis of the inter-server quality information between its own client apparatus 111 and the server 113 or the inter-server quality information of the transmission path between each of the n client apparatuses 111 and the server 113. The control unit 134 generates final tactile sensation information on the basis of the transmission path tactile sensation information and the game tactile sensation information supplied from the reception control unit 135, and supplies the final tactile sensation information to the interface 31.

The reception control unit 135 controls reception of a transmission packet transmitted from the server 113 via the transmission path. Similarly to the reception control unit 35, the reception control unit 135 analyzes the content of the payload of the transmission packet received by this control. The reception control unit 135 supplies the game force sensation information, the game tactile sensation information, the force sensation control request, and the tactile sensation control request included as payloads in the transmission packet to the control unit 134 on the basis of the analysis result. On the basis of the analysis result, the reception control unit 135 supplies the encoded video included in the transmission packet as a payload to the video decoder 36, and supplies the encoded audio to the audio decoder 38.

Note that, in a case where the meta information is added to the video (audio) included in the transmission packet, the meta information is also supplied to the video decoder 36 (audio decoder 38) together with the video (audio), and is used in the video decoder 36 (audio decoder 38), for example.

Each of the controller apparatuses 112-1 to 112-n is connected to each of the client apparatuses 111-1 to 111-n in a wired or wireless manner. Since the configuration of the controller apparatus 112 is similar to the configuration of the controller apparatus 12, the description thereof will be omitted.

The server 113 is different from the server 13 in that the reception control unit 71, the complementing unit 72, the game engine 73, and the video encoder 75 are replaced with the reception control unit 171, the complementing unit 172, the game engine 173, and the video decoder 175, respectively. The server 113 is also different from the server 13 in that the audio encoder 76 and the transmission control unit 77 are replaced with an audio decoder 176 and a transmission control unit 177, respectively, and that a request unit 178 is newly provided. The other configurations are similar to those of the server 13.

The reception control unit 171 controls reception of transmission packets transmitted from each of the n client apparatuses 111 via the transmission path. Similarly to the reception control unit 71, the reception control unit 171 analyzes the content of the payload of the transmission packet received by this control. The reception control unit 171 supplies the complementing unit 72 with the displacement information and the inter-server quality information of each client apparatus 111 included as a payload in the transmission packet on the basis of the analysis result. Note that, similarly to the reception control unit 71, the reception control unit 171 also supplies the meta information included in the received packet of the displacement information to the complementing unit 72.

The reception control unit 171 supplies the inter-server quality information of each client apparatus 111 included as a payload in the transmission packet to the request unit 178 on the basis of the analysis result.

The complementing unit 172 complements the displacement information of each client apparatus 111 on the basis of the inter-server quality information of the n client apparatuses 111 supplied from the reception control unit 171. For example, in a case where a state in which the risk indicated by the inter-server quality information of one or more client apparatuses 111 exceeds the threshold value th2 continues for the timeout period D or more, the complementing unit 172 changes the displacement information of all the client apparatuses 11 to the displacement information indicating the displacement to the initial position. The complementing unit 172 supplies the displacement information complemented by the change to the game engine 173.

Similarly to the game engine 73, the game engine 173 executes a game stored in the database 74 on the basis of the displacement information supplied from the complementing unit 172 for each client apparatus 111, and generates game force sensation information and game tactile sensation information.

The game engine 173 supplies the video of the game generated by the execution of the game to the video encoder 175 and supplies the audio to the audio encoder 176 for each client apparatus 111. The game engine 173 supplies the game force sensation information and the game tactile sensation information of each client apparatus 111 to the transmission control unit 177.

For each client apparatus 111, the video encoder 175 encodes the video supplied from the game engine 173 by a method suitable for the transmission path between the client apparatus 11 and the server 13, and supplies the encoded video to the transmission control unit 177.

For each client apparatus 111, the audio encoder 176 encodes the audio supplied from the game engine 173 by a method suitable for the transmission path between the client apparatus 11 and the server 13, and supplies the encoded audio to the transmission control unit 177.

The transmission control unit 177 packetizes the force sensation control request and the tactile sensation control request supplied from the request unit 178. Similarly to the transmission control unit 77, the transmission control unit 177 generates a transmission packet from the resultant packets of the force sensation control request and the tactile sensation control request. The transmission control unit 177 performs control such that the transmission packet is transmitted to the client apparatus 111 as a transmission destination supplied from the request unit 178 via a transmission path.

The transmission control unit 177 packetizes the game force sensation information and the game tactile sensation information, the encoded video, and the encoded audio for each client apparatus 111. Similarly to the transmission control unit 77, the transmission control unit 177 generates a transmission packet from packets of game force sensation information, game tactile sensation information, video, and audio obtained as a result of packetization for each client apparatus 111. The transmission control unit 177 performs control so that the transmission packet of each client apparatus 111 is transmitted to the client apparatus 111 via the transmission path.

Note that, similarly to the transmission control unit 77, the transmission control unit 177 can add meta information of video or audio to video or audio when the video or audio is packetized.

The request unit 178 generates a force sensation control request on the basis of the inter-server quality information of the n client apparatuses 111 supplied from the reception control unit 171. Specifically, the request unit 178 generates the transmission path force sensation information for each client apparatus 111 on the basis of the inter-server quality information similarly to the control unit 34 in FIG. 2. In a case where the transmission path force sensation information includes force sensation information for performing control so as to present an initial position force sensation, the request unit 178 generates a force sensation control request for requesting generation of the force sensation information. In a case where all the generated transmission path force sensation information is force sensation information for performing control so as to present a displacement suppression force sensation, the request unit 178 generates a force sensation control request for requesting generation of the force sensation information. The request unit 178 supplies the force sensation control request to the transmission control unit 177.

The request unit 178 generates a tactile sensation control request on the basis of the inter-server quality information of the n client apparatuses 111 supplied from the reception control unit 171. Specifically, the request unit 178 generates transmission path tactile sensation information for each client apparatus 111 on the basis of the inter-server quality information, similarly to the control unit 34. In a case where the transmission path tactile sensation information is generated, the request unit 178 generates a tactile sensation control request for requesting generation of the transmission path tactile sensation information, and supplies the tactile sensation control request to the transmission control unit 177.

In a case where both the force sensation control request and the tactile sensation control request are generated, the request unit 178 selects the client apparatus 111 corresponding to the transmission path force sensation information and the transmission path tactile sensation information used for generation of both the force sensation control request and the tactile sensation control request as the client apparatus 111 having the worst transmission path quality. In a case where only the force sensation control request is generated, the request unit 178 selects the client apparatus 111 corresponding to the transmission path force sensation information used to generate the force sensation control request as the client apparatus 111 having the worst quality of the transmission path. The request unit 178 supplies the client apparatus 111 other than the client apparatus 111 having the worst transmission path quality to the transmission control unit 177 as a transmission destination.

### <Description of Gaming Session Processing>

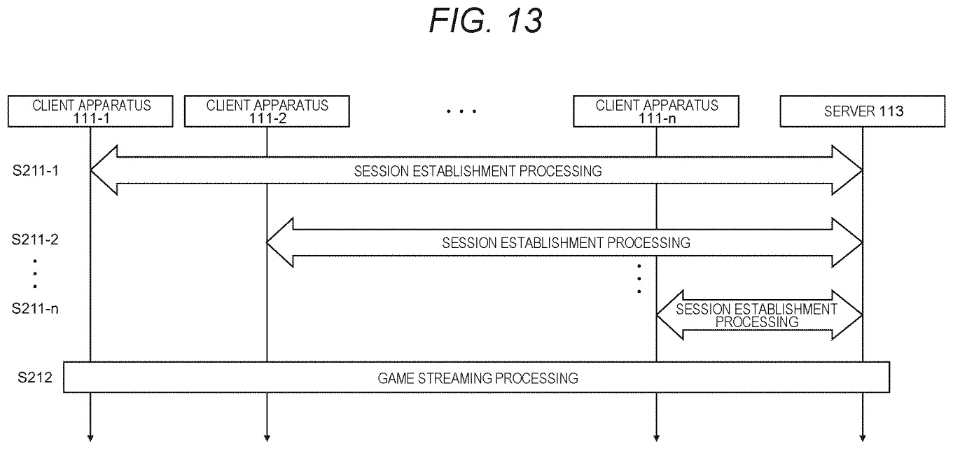

FIG. 13 is a flowchart for explaining gaming session processing by the n client apparatuses 111 and the server 113.

In step S211-1 of FIG. 13, the client apparatus 111-1 and the server 113 perform session establishment processing similar to the session establishment processing of FIG. 8. Similarly in step S211-2 and subsequent steps, in step S211-i (i=2, . . . , n), the client apparatus 111-i and the server 113 perform session establishment processing similar to the session establishment processing in FIG. 8. As described above, in steps S211-1 to 211-n, the session establishment processing is performed between each client apparatus 111 and the server 113.

In step S212, the n client apparatuses 111 and the server 113 perform game streaming processing. In this game streaming processing, each client apparatus 111 transmits the displacement information to the server 113, and the server 113 executes the game on the basis of the displacement information to generate video and audio of the game, and transmits the video and audio to the client apparatus 111. As a result, the video of the game is displayed on the display 37 of each client apparatus 111, and the audio of the game is output from the speaker 39. After the processing in step S212, the session ends, and the gaming session processing ends.

### <Description of Control Processing>

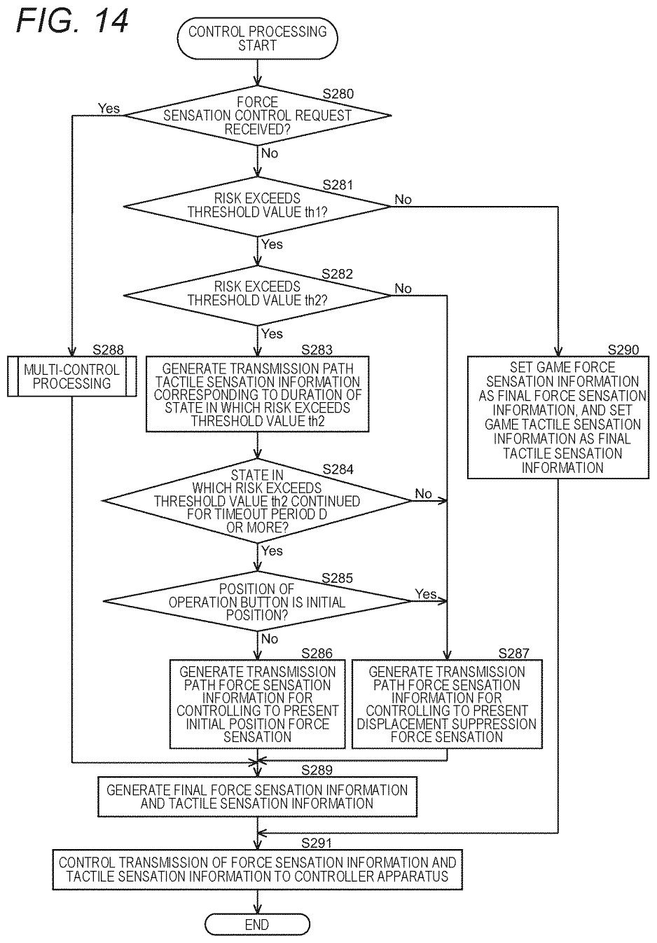

FIG. 14 is a flowchart for explaining control processing performed by the client apparatus 111 in the game streaming processing in step S212 in FIG. 13. This control processing is started, for example, when new inter-server quality information is supplied from the estimation unit 33 to the control unit 134. Alternatively, this control processing is started when new game force sensation information, game tactile sensation information, force sensation control request, or tactile sensation control request received from the server 13 under the control of the reception control unit 135 is supplied to the control unit 134.

Note that, in the example of FIG. 14, it is assumed that the first inter-server estimation processing of FIG. 9 is performed before the control processing of FIG. 14.

In step S280 of FIG. 14, the control unit 134 determines whether or not the force sensation control request transmitted from the server 13 has been received under the control of the reception control unit 135. In a case where it is determined in step S280 that the force sensation control request has not been received, that is, in a case where it is determined that the force sensation control request has not been supplied from the reception control unit 135 to the control unit 134, the processing proceeds to step S281.

Since the processing of steps S281 to S287 is similar to the processing of steps S81 to S87 of FIG. 10, the description thereof will be omitted.

On the other hand, in a case where it is determined in step S280 that the force sensation control request has been received, that is, in a case where it is determined that the force sensation control request has been supplied from the reception control unit 135 to the control unit 134, the processing proceeds to step S288.

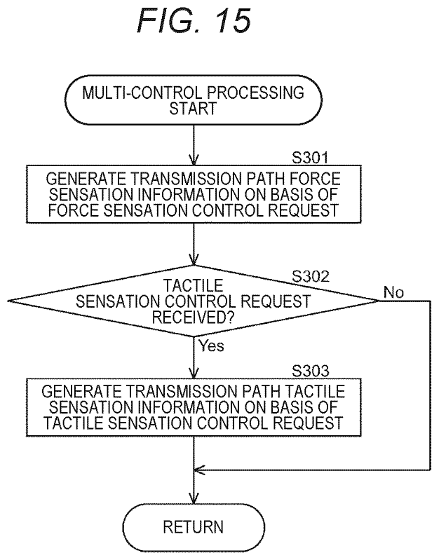

In step S288, the control unit 134 performs multi-control processing of generating transmission path force sensation information on the basis of the force sensation control request and generating transmission path tactile sensation information on the basis of the tactile sensation control request. Details of the multi-control processing will be described later with reference to FIG. 15. After the processing of step S288, the processing proceeds to step S289. Since the processing of steps S289 to S291 is similar to the processing of steps S88 to S90, the description thereof will be omitted.

Note that, in a case where the first inter-server estimation processing is not performed before the control processing of FIG. 14, the game force sensation information and the game tactile sensation information are transmitted to the controller apparatus 112 as the final force sensation information and the final tactile sensation information until the first inter-server estimation processing is performed.

The control unit 134 may transmit at least one of the changed force sensation information or tactile sensation information to the controller apparatus 112 via the interface 31 only in a case where at least one of the final force sensation information or the tactile sensation information has changed.

### <Description of Multi-Control Processing>

FIG. 15 is a flowchart for explaining the multi-control processing in step S288 in FIG. 14 in detail.

In step S301 of FIG. 15, the control unit 134 generates transmission path force sensation information on the basis of the force sensation control request supplied from the reception control unit 135.

In step S302, the control unit 134 determines whether or not the tactile sensation control request transmitted from the server 13 has been received under the control of the reception control unit 135. In a case where it is determined in step S302 that the tactile sensation control request has been received, that is, in a case where it is determined that the tactile sensation control request has been supplied from the reception control unit 135 to the control unit 134, the processing proceeds to step S303.

In step S303, the control unit 134 generates transmission path tactile sensation information on the basis of the tactile sensation control request supplied from the reception control unit 135. Then, the processing returns to step S288 in FIG. 14 and proceeds to step S289.

On the other hand, in a case where it is determined in step S302 that the tactile sensation control request has not been received, that is, in a case where it is determined that the tactile sensation control request has not been supplied from the reception control unit 135 to the control unit 134, the processing returns to step S288 in FIG. 14 and proceeds to step S289.

Note that the complementing processing by the complementing unit 172 is similar to the complementing processing of FIG. 11 except that the complementing processing is performed on the basis of the inter-server quality information of the n client apparatuses 111, and thus, description thereof is omitted.

### <Description of Request Processing>

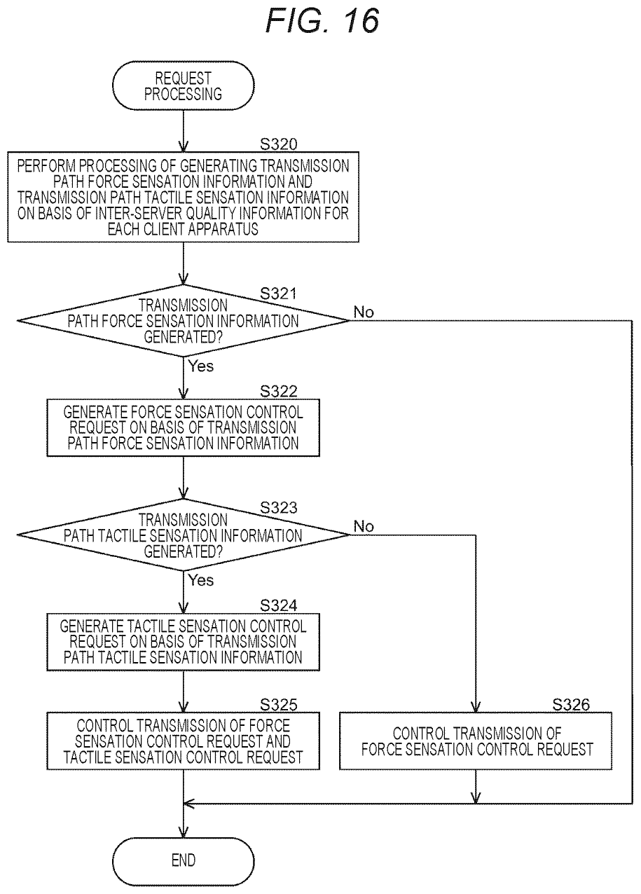

FIG. 16 is a flowchart for explaining request processing for generating a force sensation control request or a tactile sensation control request performed by the server 113 in the game streaming processing in step S212 in FIG. 13. This request processing is started, for example, when new inter-server quality information is supplied from the reception control unit 171.

In step S320 of FIG. 16, the request unit 178 performs, for each client apparatus 111, processing of generating transmission path force sensation information and transmission path tactile sensation information on the basis of the inter-server quality information of the client apparatus 111, similarly to the control unit 34.

In step S321, the request unit 178 determines whether or not the transmission path force sensation information of one or more client apparatuses 111 has been generated by the processing in step S320. In a case where it is determined in step S321 that the transmission path force sensation information of one or more client apparatuses 111 has been generated, the processing proceeds to step S322.

In step S322, the request unit 178 generates a force sensation control request on the basis of the generated transmission path force sensation information of one or more client apparatuses 111, and supplies the force sensation control request to the transmission control unit 177.

In step S323, the request unit 178 determines whether or not the transmission path tactile sensation information of one or more client apparatuses 111 has been generated by the processing in step S320. In a case where it is determined in step S321 that the transmission path tactile sensation information of one or more client apparatuses 111 has been generated, the processing proceeds to step S324.

In step S324, the request unit 178 generates a tactile sensation control request on the basis of the generated transmission path tactile sensation information of one or more client apparatuses 111, and supplies the tactile sensation control request to the transmission control unit 177. Then, the request unit 178 selects the client apparatus 111 corresponding to both the transmission path force sensation information used in the processing of step S322 and the transmission path tactile sensation information used in the processing of step S324 as the client apparatus 111 having the worst quality of the transmission path. The request unit 178 supplies a client apparatus other than the client apparatus 111 to the transmission control unit 177 as a transmission destination of the force sensation control request and the tactile sensation control request.

In step S325, the transmission control unit 177 controls transmission of the force sensation control request generated in step S322 and the tactile sensation control request generated in step S324 to the client apparatus 111 as a transmission destination supplied from the request unit 178. Then, the request processing ends.

On the other hand, in a case where it is determined in step S323 that the transmission path tactile sensation information of one client apparatus 111 is not also generated, the request unit 178 selects the client apparatus 111 having the worst quality of the transmission path. Specifically, the request unit 178 selects the client apparatus 111 corresponding to the transmission path force sensation information used in the processing of step S322 as the client apparatus 111 having the worst quality of the transmission path. The request unit 178 supplies a client apparatus other than the client apparatus 111 to the transmission control unit 177 as a transmission destination of the force sensation control request. Then, the processing proceeds to step S326.

In step S326, the transmission control unit 177 controls transmission of the force sensation control request generated in step S322 to the client apparatus 111 that is a transmission destination supplied from the request unit 178. Then, the request processing ends.

In a case where it is determined in step S321 that one piece of transmission path force sensation information has not been generated, the request processing ends.

Note that the processing in step S320 may not be processing similar to the processing performed by the control unit 34 as long as it is processing of generating the transmission path force sensation information or the transmission path tactile sensation information in a case where it is determined that the quality of the transmission path is equal to or less than the predetermined quality for each client apparatus 111. For example, the processing of step S320 may be processing of generating the transmission path force sensation information or the transmission path tactile sensation information in a case where it is determined that the transmission packet including the inter-server quality information is not periodically received for each client apparatus 111.

As described above, in the game streaming system 110, the server 113 is connected to the n client apparatuses 111. The request unit 178 of the server 113 generates a force sensation control request for requesting generation of transmission path force sensation information corresponding to the client apparatus 111 having the worst quality of the transmission path on the basis of the inter-server quality information of the transmission path with each client apparatus 111. The transmission control unit 177 transmits the force sensation control request to the client apparatus 111 other than the client apparatus 111 having the worst quality of the transmission path.

As a result, each client apparatus 11 generates transmission path force sensation information for performing control so that the operation buttons 12a corresponding to all the n client apparatuses 111 present a force sensation presented by the operation buttons 12a corresponding to the client apparatus 111 having the worst quality of the transmission path. As a result, in the game streaming system 110, in a case where multi-users (multi-players) compete in a game, it is possible to alleviate the unfairness of the operational feeling due to the state of the transmission path used by the client apparatus 111 of each user and secure the fairness between the users. As a result, it is possible to suppress degradation of the quality of the user experience due to the quality of the transmission path for transmitting the displacement information.

Note that, in a case where the transmission path force sensation information corresponding to the force sensation control request is force sensation information for performing control so as to present a displacement suppression force sensation, the intensity of the displacement suppression force sensation corresponding to the transmission path force sensation information may be included in the force sensation control request and notified. In this case, on the basis of the force sensation control request, the control unit 134 generates transmission path force sensation information for performing control so as to present a displacement suppression force sensation of intensity included in the force sensation control request. As a result, the intensity of the displacement suppression force sensation presented to the user of the client apparatus 111 having the worst transmission path quality and the intensity of the displacement suppression force sensation presented to the user of the client apparatus 111 other than the client apparatus 111 can be made the same. The control unit 134 may generate transmission path force sensation information for performing control so as to present a displacement suppression force sensation having a preset intensity on the basis of the force sensation control request.

Similarly, with respect to the tactile sensation control request, the intensity or continuous time of the tactile sensation corresponding to the transmission path tactile sensation information used to generate the tactile sensation control request may be included in the tactile sensation control request. On the basis of the tactile sensation control request, the control unit 134 may generate transmission path tactile sensation information for performing control so as to present a tactile sensation of a preset intensity or duration.

Even in a case where the force sensation control request or the transmission path tactile sensation information is transmitted from the server 113, the client apparatus 111 may generate the transmission path force sensation information or the transmission path tactile sensation information on the basis of its own inter-server quality information. In this case, for example, the control unit 134 sets, as the final transmission path force sensation information, transmission path force sensation information for performing control so as to present a stronger force sensation out of the transmission path force sensation information based on the force sensation control request and the transmission path force sensation information based on its own inter-server quality information. The transmission path tactile sensation information is similar to the transmission path force sensation information.

Similarly to the estimation unit 33, the server 113 may include an estimation unit that estimates the quality of the transmission path with each client apparatus 111. In this case, the request unit 178 uses the inter-server quality information of each client apparatus 111 generated by the estimation unit instead of the inter-server quality information transmitted from each client apparatus 111.

The force sensation control request and the tactile sensation control request may also be transmitted to the client apparatus 111 having the worst quality of the transmission path.

### 3. Third Embodiment

### <Configuration Example of Game Streaming System>

FIG. 17 is a block diagram illustrating a configuration example of a third embodiment of a game streaming system to which the present technology is applied.

In the game streaming system 210 of FIG. 17, portions corresponding to those of the game streaming system 10 of FIG. 2 are denoted by the same reference signs. Therefore, description of the portion will be appropriately omitted, and description will be given focusing on a portion different from the game streaming system 10.

The game streaming system 210 includes a client apparatus 211, a controller apparatus 212, and a server 213. In the game streaming system 210, the client apparatus 211 and the controller apparatus 212 are wirelessly connected. Therefore, the quality of the transmission path between the client apparatus 211 and the controller apparatus 212 is also estimated, and the transmission path force sensation information and the transmission path tactile sensation information are generated on the basis of the quality.

Specifically, the client apparatus 211 is different from the client apparatus 11 in that the interface 31, the transmission control unit 32, and the estimation unit 233 are replaced with the interface 231, the transmission control unit 232, and the estimation unit 233, respectively. The other configurations are similar to those of the client apparatus 11.

The interface 231 controls transmission and reception of information to and from the controller apparatus 212. Specifically, the interface 231 controls reception of the position information and the inter-controller apparatus quality information transmitted from the controller apparatus 12 via the transmission path. The inter-controller apparatus quality information is quality information of a transmission path between the client apparatus 211 and the controller apparatus 212.

The interface 231 generates overall quality information on the basis of the received inter-controller apparatus quality information and the inter-server quality information supplied from the estimation unit 233. Specifically, the interface 231 generates the overall quality information by combining the inter-controller apparatus quality information and the inter-server quality information. The overall quality information is quality information of a transmission path between the controller apparatus 212 and the server 213 via the client apparatus 211. The interface 231 supplies the overall quality information and the position information to the transmission control unit 232.

The interface 231 performs control such that the game force sensation information, the game tactile sensation information, and the inter-server quality information received under the control of the reception control unit 35 are transmitted to the controller apparatus 12 via the transmission path.

In a case where the position information supplied from the interface 231 changes, the transmission control unit 232 generates the displacement information on the basis of the position information. The transmission control unit 232 packetizes the displacement information and the overall quality information supplied from the interface 231. Similarly to the transmission control unit 32 in FIG. 2, the transmission control unit 232 generates a transmission packet from the resultant packet. The transmission control unit 232 performs control such that the transmission packet is transmitted to the server 213 via the transmission path.

The estimation unit 233 is different from the estimation unit 33 in FIG. 2 in that the inter-server quality information is supplied to the interface 231, and is similar to the estimation unit 33 in the other respects.

The controller apparatus 212 is different from the controller apparatus 12 in that the interface 51 is replaced with the interface 251 and that an estimation unit 254 and a control unit 255 are newly provided, and is configured similarly to the controller apparatus 12 in the other respects.

The interface 251 (communication control unit) controls transmission and reception of information to and from the client apparatus 11. Specifically, the interface 251 performs control such that the inter-controller apparatus quality information supplied from the estimation unit 254 and the position information supplied from the control unit 255 are transmitted to the client apparatus 211 via the transmission path. The interface 251 controls reception of the game force sensation information, the game tactile sensation information, and the inter-server quality information transmitted from the client apparatus 211 via the transmission path, and supplies the received game force sensation information, game tactile sensation information, and inter-server quality information to the control unit 255.

Similarly to the estimation unit 33 in FIG. 2, the estimation unit 254 collects various metrics of the transmission path between the client apparatus 211 and the controller apparatus 212 via the interface 251. Similarly to the estimation unit 33, the estimation unit 254 periodically estimates the quality of the transmission path on the basis of the collected metric and generates the inter-controller apparatus quality information. The estimation unit 254 supplies the inter-controller apparatus quality information to the interface 251 and the control unit 255.

Similarly to the interface 231, the control unit 255 generates the overall quality information on the basis of the inter-server quality information supplied from the interface 251 and the inter-controller apparatus quality information supplied from the estimation unit 254.

Similarly to the control unit 34 in FIG. 2, the control unit 255 generates transmission path force sensation information on the basis of the overall quality information and the position information supplied from the control unit 52. The control unit 255 generates final force sensation information on the basis of the transmission path force sensation information and the game force sensation information supplied from the interface 251, and supplies the final force sensation information to the control unit 52.

Similarly to the control unit 34, the control unit 255 generates transmission path tactile sensation information on the basis of the overall quality information. The control unit 255 generates final tactile sensation information on the basis of the transmission path tactile sensation information and the game tactile sensation information supplied from the interface 251, and supplies the final tactile sensation information to the control unit 52. The control unit 255 supplies the position information generated by the control unit 52 to the interface 251.

The server 213 is different from the server 13 in that the reception control unit 71 and the complementing unit 72 are replaced with the reception control unit 271 and the complementing unit 272, respectively, and is configured similarly to the server 13 in the other respects.

The reception control unit 271 controls reception of a transmission packet transmitted from the client apparatus 11 via the transmission path. Similarly to the reception control unit 71, the reception control unit 271 analyzes the content of the payload included in the transmission packet received by this control. The reception control unit 271 supplies the displacement information and the overall quality information included in the transmission packet as a payload to the complementing unit 272 on the basis of the analysis result. Note that, in a case where the meta information is included in the received packet of the displacement information, the meta information is also supplied to the complementing unit 272.

The complementing unit 272 complements the displacement information on the basis of the overall quality information supplied from the reception control unit 271 and supplies the same to the game engine 73.

Note that the gaming session processing by the game streaming system 210 is different from the gaming session processing in FIG. 7 in that control processing is not performed in the game streaming processing. The gaming session processing by the game streaming system 210 is also different from the gaming session processing of FIG. 7 in that the overall quality information is used instead of the inter-server quality information in the complementing processing. The other processing is similar to the gaming session processing of FIG. 7. Therefore, description of gaming session processing by the game streaming system 210 is omitted.

### <Description of Inter-Controller Estimation Processing>

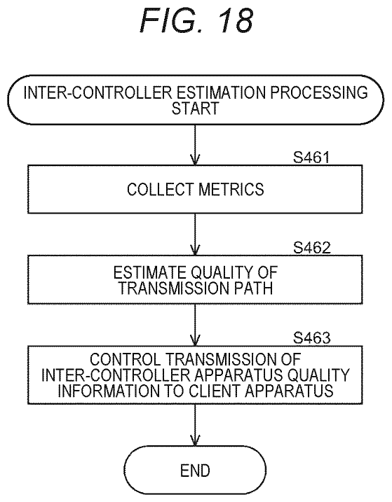

FIG. 18 is a flowchart for explaining inter-controller estimation processing for estimating the quality of the transmission path between the client apparatus 211 and the controller apparatus 212 performed by the controller apparatus 212 in a case where the game streaming processing is performed. The inter-controller estimation processing is periodically performed, for example.

In step S461 of FIG. 18, the estimation unit 254 collects various metrics of the transmission path between the client apparatus 211 and the controller apparatus 212 via the interface 251.

In step S462, the estimation unit 254 estimates the quality of the transmission path on the basis of the metric collected in step S461, and generates the inter-controller apparatus quality information. The estimation unit 254 supplies the inter-controller apparatus quality information to the interface 251 and the control unit 255.

In step S463, the interface 251 controls transmission of the inter-controller apparatus quality information supplied from the estimation unit 254 to the client apparatus 211. As a result, the client apparatus 211 generates the overall quality information on the basis of the inter-controller apparatus quality information and the inter-server quality information, and transmits the overall quality information to the server 213. After the processing of step S463, the estimation processing ends.

### <Description of Overall Control Processing>

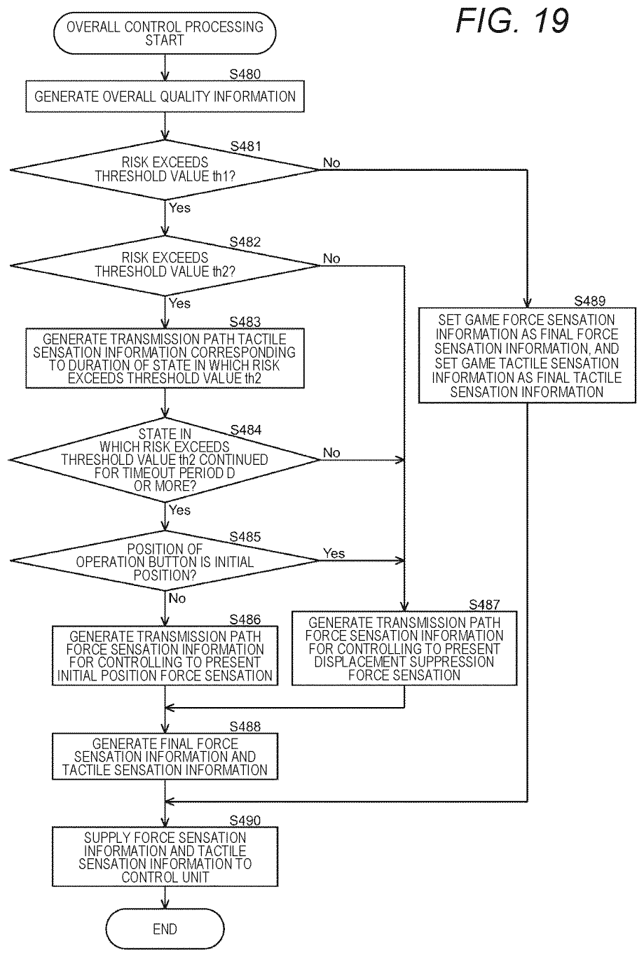

FIG. 19 is a flowchart for explaining overall control processing for controlling presentation of a force sensation and a tactile sensation on the basis of overall quality information, the overall control processing being performed by the controller apparatus 212 in a case where game streaming processing is being performed. This overall control processing is started, for example, when new inter-controller apparatus quality information is supplied from the estimation unit 254 to the control unit 255, or when new game force sensation information, game tactile sensation information, or inter-server quality information is received under the control of the interface 251.

Note that, in the example of FIG. 19, it is assumed that the first inter-server estimation processing of FIG. 9 and the first inter-controller apparatus estimation processing of FIG. 18 are performed before the control processing of FIG. 19.

In step S480 of FIG. 19, the control unit 255 generates overall quality information on the basis of the inter-server quality information received under the control of the interface 251 and the inter-controller apparatus quality information supplied from the estimation unit 254.

The processing in steps S481 to S489 is different from the processing in steps S81 to S89 in FIG. 10 in that the control unit 34 and the inter-server quality information are replaced with the control unit 255 and the overall quality information, respectively, and the final force sensation information and tactile sensation information are not supplied to the interface 31. The other processing is similar to the processing in steps S81 to S89. Therefore, description thereof is omitted.

In step S490, the control unit 255 supplies the final force sensation information and tactile sensation information to the control unit 52. As a result, the operation button 12a presents a force sensation based on the force sensation information, and the voice coil motor 53 presents a tactile sensation based on the tactile sensation information. After the processing of step S490, the overall control processing ends.

Note that, in a case where the first inter-server estimation processing and the first inter-controller apparatus estimation processing are not performed before the overall control processing in FIG. 19, the game force sensation information and the game tactile sensation information received from the server 213 are the final force sensation information and the final tactile sensation information until these processing are performed.

The control unit 34 may supply at least one of the changed force sensation information or tactile sensation information to the control unit 52 only in a case where at least one of the final force sensation information or the tactile sensation information has changed.

As described above, the interface 251 of the controller apparatus 212 controls transmission such that the position information is transmitted to the client apparatus 211 via the transmission path. The control unit 255 controls presentation of a force sensation by the operation button 12a on the basis of the overall quality information. Therefore, the presentation of the force sensation by the operation button 12a can be controlled on the basis of the quality of the transmission path between the controller apparatus 212 and the server 213 via the client apparatus 211.

As a result, even in a case where the position information is missing between the client apparatus 211 and the controller apparatus 212, it is possible to suppress deterioration of the quality of the user experience due to the quality of the transmission path similarly to the case of the first embodiment.

Note that the control unit 255 may be provided in the client apparatus 211. In this case, the controller apparatus 212 transmits the inter-controller apparatus quality information to the client apparatus 211, and the final force sensation information and tactile sensation information generated by the control unit 255 are transmitted to the controller apparatus 212.

The controller apparatus 12 (112, 212) may transmit not the position information but the displacement information to the client apparatus 11 (111, 211).

The time for presenting the displacement suppression force sensation may be a predetermined time. In this case, in the second embodiment, this time may be included in the force sensation control request or may be determined in advance.

### <4. Computer>

The above-described series of processing can be executed by hardware or software. In a case where the series of processing is executed by software, a program constituting the software is installed in a computer. Here, the computer includes a computer incorporated in dedicated hardware, a general-purpose personal computer capable of executing various functions by installing various programs, and the like, for example.

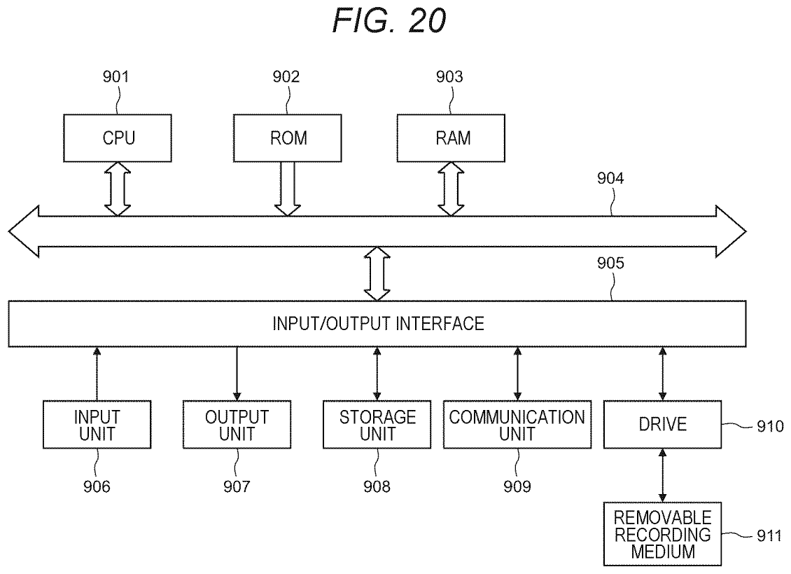

FIG. 20 is a block diagram illustrating a configuration example of hardware of a computer that executes the above-described series of processing by a program.

In the computer, a central processing unit (CPU) 901, a read only memory (ROM) 902, and a random access memory (RAM) 903 are mutually connected by a bus 904.

An input/output interface 905 is further connected to the bus 904. An input unit 906, an output unit 907, a storage unit 908, a communication unit 909, and a drive 910 are connected to the input/output interface 905.

The input unit 906 includes a keyboard, a mouse, a microphone, and the like. The output unit 907 includes a display, a speaker, and the like. The storage unit 908 includes a hard disk, a nonvolatile memory, and the like. The communication unit 909 includes a network interface and the like. The drive 910 drives a removable medium 911 such as a magnetic disk, an optical disk, a magneto-optical disk, or a semiconductor memory.

In the computer configured as described above, for example, the CPU 901 loads a program stored in the storage unit 908 into the RAM 903 via the input/output interface 905 and the bus 904 and executes the program, whereby the above-described series of processing is performed.

The program executed by the computer (CPU 901) can be provided by being recorded in the removable medium 911 as a package medium or the like, for example. Furthermore, the program can be provided via a wired or wireless transmission medium such as a local area network, the Internet, or digital satellite broadcasting.

In the computer, the program can be installed in the storage unit 908 via the input/output interface 905 by attaching the removable medium 911 to the drive 910. Furthermore, the program can be received by the communication unit 909 via a wired or wireless transmission medium and installed in the storage unit 908. In addition, the program can be installed in the ROM 902 or the storage unit 908 in advance.

Note that the program executed by the computer may be a program in which processing is performed in time series in the order described in the present specification, or may be a program in which processing is performed in parallel or at necessary timing such as when a call is made.

The embodiments of the present technology are not limited to the above-described embodiments, and various modifications can be made without departing from the gist of the present technology.

For example, a form in which all or some of the plurality of embodiments described above are combined can be adopted.

For example, the present technology can have a configuration of cloud computing in which one function is shared and processed in cooperation by a plurality of apparatuses via a network.

Furthermore, each step described in the above-described flowchart can be executed by one apparatus or can be shared and executed by a plurality of apparatuses.

Furthermore, in a case where a plurality of processes is included in one step, the plurality of processes included in the one step can be executed by one apparatus or can be shared and executed by a plurality of apparatuses.

Note that the effects described in the present specification are merely examples and are not limited, and effects other than those described in the present specification may be provided.

The present technology can have the following configurations.

(1)

An information processing apparatus including:
a transmission control unit that performs control such that displacement information that indicates displacement of an operation unit that is displaced according to an operation of a user and presents a force sensation to the user is transmitted to another information processing apparatus via a first transmission path; and
a control unit that controls presentation of the force sensation by the operation unit on the basis of quality of the first transmission path.
   (2)

The information processing apparatus according to (1), in which
the control unit performs control to present the force sensation for suppressing the displacement of the operation unit on the basis of the quality of the first transmission path.
   (3)

The information processing apparatus according to (1) or (2), in which
in a case where a state in which the quality of the first transmission path is a predetermined quality continues for a predetermined time or more, the control unit performs control to present the force sensation in which the operation unit is displaced to an initial position.
   (4)

The information processing apparatus according to (3), in which
the predetermined time is shared with the another information processing apparatus.
   (5)

The information processing apparatus according to (3) or (4), in which
the operation unit presents the force sensation and a tactile sensation to the user, and
the control unit also controls presentation of the tactile sensation according to duration of the state in a case where the state continues for the predetermined time or more.
   (6)

The information processing apparatus according to any one of (1) to (5), further including
an estimation unit that estimates the quality of the first transmission path.
   (7)

The information processing apparatus according to (6), in which
the transmission control unit performs control such that quality information indicating the quality estimated by the estimation unit is transmitted.
   (8)

The information processing apparatus according to any one of (1) to (7), further including
a reception control unit that controls reception of a presentation request of the force sensation transmitted from the another information processing apparatus via the first transmission path, in which
the another information processing apparatus performs communication with an information processing apparatus other than the information processing apparatus via a second transmission path, and generates the request on the basis of quality of the first transmission path and the second transmission path, and
the control unit controls presentation of the force sensation on the basis of the request received by control of the reception control unit.
   (9)

An information processing method in which
an information processing apparatus includes:
a transmission control step of performing control such that displacement information that indicates displacement of an operation unit that is displaced according to an operation of a user and presents a force sensation to the user is transmitted to another information processing apparatus via a first transmission path; and
a control step of controlling presentation of the force sensation by the operation unit on the basis of quality of the first transmission path.
   (10)

A program for causing a computer to function as an information processing apparatus including:
a transmission control unit that performs control such that displacement information that indicates displacement of an operation unit that is displaced according to an operation of a user and presents a force sensation to the user is transmitted to another information processing apparatus via a first transmission path; and
a control unit that controls presentation of the force sensation by the operation unit on the basis of quality of the first transmission path.
   (11)

An information processing apparatus including:
a reception control unit that controls reception of displacement information that is transmitted from another information processing apparatus via a transmission path and indicates displacement of an operation unit that is displaced in accordance with an operation of a user, and presents a force sensation to the user;
a complementing unit that complements the displacement information received under control of the reception control unit; and
a processing unit that performs processing on the basis of the displacement information complemented by the complementing unit, in which
in a case where a state in which quality of the transmission path is a predetermined quality continues for a predetermined time or more, the complementing unit performs complementation by changing the displacement information received under the control of the reception control unit to displacement information indicating displacement of the operation unit to an initial position.
   (12)

The information processing apparatus according to (11), in which
the predetermined time is shared with the another information processing apparatus.
   (13) The information processing apparatus according to (11) or (12), further including:
a request unit that generates a force sensation control request for requesting each of a plurality of other information processing apparatuses to control the force sensation such that a plurality of the operation unit corresponding to the plurality of other information processing apparatuses present the same force sensation on the basis of quality of the transmission path with each of the plurality of other information processing apparatuses; and
a transmission control unit that performs control such that the force sensation control request generated by the request unit is transmitted to each of the plurality of other information processing apparatuses via the transmission path.
   (14)

An information processing method in which
an information processing apparatus includes:
a reception control step of controlling reception of displacement information that is transmitted from another information processing apparatus via a transmission path and indicates displacement of an operation unit that is displaced in accordance with an operation of a user, and presents a force sensation to the user;
a complementing step of complementing the displacement information received under control of the reception control step; and
a processing step of performing processing on the basis of the displacement information complemented by the processing of the complementing step, in which
in processing of the complementing step, in a case where a state in which quality of the transmission path is a predetermined quality continues for a predetermined time or more, complementation is performed by changing the displacement information received under the control of the reception control step to displacement information indicating displacement of the operation unit to an initial position.
   (15)

A program for causing a computer to function as an information processing apparatus including:
a reception control unit that controls reception of displacement information that is transmitted from another information processing apparatus via a transmission path and indicates displacement of an operation unit that is displaced in accordance with an operation of a user, and presents a force sensation to the user;
a complementing unit that complements the displacement information received under control of the reception control unit; and
a processing unit that performs processing on the basis of the displacement information complemented by the complementing unit, in which
in a case where a state in which quality of the transmission path is a predetermined quality continues for a predetermined time or more, the complementing unit performs complementation by changing the displacement information received under the control of the reception control unit to displacement information indicating displacement of the operation unit to an initial position.
   (16)

An information processing apparatus including:
a communication control unit that performs control such that position information that indicates a position of an operation unit that is displaced according to an operation of a user and presents a force sensation to the user is transmitted to another first information processing apparatus via a first transmission path; and
a control unit that controls presentation of the force sensation by the operation unit on the basis of quality of the first transmission path and quality of a second transmission path between the another first information processing apparatus and another second information processing apparatus, in which
the another first information processing apparatus transmits displacement information indicating displacement generated on the basis of the position information to the another second information processing apparatus via the second transmission path.
   (17)

The information processing apparatus according to (16), in which
the communication control unit also controls reception of quality information indicating quality of the second transmission path transmitted from the another first information processing apparatus via the first transmission path, and
the control unit controls the presentation of the force sensation on the basis of the quality of the first transmission path and the quality information received under the control of the communication control unit.
   (18)

The information processing apparatus according to (16), further including
an estimation unit that estimates quality of the first transmission path, in which
the control unit controls the presentation of the force sensation on the basis of the quality of the first transmission path and the quality of the second transmission path estimated by the estimation unit.
   (19)

An information processing method in which
an information processing apparatus includes:
a communication control step of performing control such that position information that indicates a position of an operation unit that is displaced according to an operation of a user and presents a force sensation to the user is transmitted to another first information processing apparatus via a first transmission path; and
a control step of controlling presentation of the force sensation by the operation unit on the basis of quality of the first transmission path and quality of a second transmission path between the another first information processing apparatus and another second information processing apparatus, in which
the another first information processing apparatus transmits displacement information indicating displacement generated on the basis of the position information to the another second information processing apparatus via the second transmission path.
   (20)

A program for causing a computer to function as an information processing apparatus including:
a communication control unit that performs control such that position information that indicates a position of an operation unit that is displaced according to an operation of a user and presents a force sensation to the user is transmitted to another first information processing apparatus via a first transmission path; and
a control unit that controls presentation of the force sensation by the operation unit on the basis of quality of the first transmission path and quality of a second transmission path between the another first information processing apparatus and another second information processing apparatus, in which
the another first information processing apparatus transmits displacement information indicating displacement generated on the basis of the position information to the another second information processing apparatus via the second transmission path.

### REFERENCE SIGNS LIST

11 Client apparatus
12 Controller apparatus
12a Operation button
12b Joystick
13 Server
32 Transmission control unit
33 Estimation unit
34 Control unit
53 Voice coil motor
71 Reception control unit
72 Complementing unit
73 Game engine
111-1 to 111-n Client apparatus
112-1 to 112-n Controller apparatus
113 Server
135 Reception control unit
134 Control unit
171 Reception control unit
172 Complementing unit
173 Game engine
177 Transmission control unit
178 Request unit
211 Client apparatus
212 Controller apparatus
213 Server
251 Interface
254 Estimation unit
255 Control unit

1. An information processing apparatus comprising:
a transmission control unit that performs control such that displacement information that indicates displacement of an operation unit that is displaced according to an operation of a user and presents a force sensation to the user is transmitted to another information processing apparatus via a first transmission path; and
a control unit that controls presentation of the force sensation by the operation unit on a basis of quality of the first transmission path.

2. The information processing apparatus according to claim 1, wherein
the control unit performs control to present the force sensation for suppressing the displacement of the operation unit on a basis of the quality of the first transmission path.

3. The information processing apparatus according to claim 1, wherein
in a case where a state in which the quality of the first transmission path is a predetermined quality continues for a predetermined time or more, the control unit performs control to present the force sensation in which the operation unit is displaced to an initial position.

4. The information processing apparatus according to claim 3, wherein
the predetermined time is shared with the another information processing apparatus.

5. The information processing apparatus according to claim 3, wherein
the operation unit presents the force sensation and a tactile sensation to the user, and
the control unit also controls presentation of the tactile sensation according to duration of the state in a case where the state continues for the predetermined time or more.

6. The information processing apparatus according to claim 1, further comprising
an estimation unit that estimates the quality of the first transmission path.

7. The information processing apparatus according to claim 6, wherein
the transmission control unit performs control such that quality information indicating the quality estimated by the estimation unit is transmitted.

8. The information processing apparatus according to claim 1, further comprising
a reception control unit that controls reception of a presentation request of the force sensation transmitted from the another information processing apparatus via the first transmission path, wherein
the another information processing apparatus performs communication with an information processing apparatus other than the information processing apparatus via a second transmission path, and generates the request on a basis of quality of the first transmission path and the second transmission path, and
the control unit controls presentation of the force sensation on a basis of the request received by control of the reception control unit.

9. An information processing method in which
an information processing apparatus includes:
a transmission control step of performing control such that displacement information that indicates displacement of an operation unit that is displaced according to an operation of a user and presents a force sensation to the user is transmitted to another information processing apparatus via a first transmission path; and
a control step of controlling presentation of the force sensation by the operation unit on a basis of quality of the first transmission path.

10. A program for causing a computer to function as an information processing apparatus including:
a transmission control unit that performs control such that displacement information that indicates displacement of an operation unit that is displaced according to an operation of a user and presents a force sensation to the user is transmitted to another information processing apparatus via a first transmission path; and
a control unit that controls presentation of the force sensation by the operation unit on a basis of quality of the first transmission path.

11. An information processing apparatus comprising:
a reception control unit that controls reception of displacement information that is transmitted from another information processing apparatus via a transmission path and indicates displacement of an operation unit that is displaced in accordance with an operation of a user, and presents a force sensation to the user;
a complementing unit that complements the displacement information received under control of the reception control unit; and
a processing unit that performs processing on a basis of the displacement information complemented by the complementing unit, wherein
in a case where a state in which quality of the transmission path is a predetermined quality continues for a predetermined time or more, the complementing unit performs complementation by changing the displacement information received under the control of the reception control unit to displacement information indicating displacement of the operation unit to an initial position.

12. The information processing apparatus according to claim 11, wherein
the predetermined time is shared with the another information processing apparatus.

13. The information processing apparatus according to claim 11, further comprising:
a request unit that generates a force sensation control request for requesting each of a plurality of other information processing apparatuses to control the force sensation such that a plurality of the operation unit corresponding to the plurality of other information processing apparatuses present the same force sensation on a basis of quality of the transmission path with each of the plurality of other information processing apparatuses; and
a transmission control unit that performs control such that the force sensation control request generated by the request unit is transmitted to each of the plurality of other information processing apparatuses via the transmission path.

14. An information processing method in which
an information processing apparatus includes:
a reception control step of controlling reception of displacement information that is transmitted from another information processing apparatus via a transmission path and indicates displacement of an operation unit that is displaced in accordance with an operation of a user, and presents a force sensation to the user;
a complementing step of complementing the displacement information received under control of the reception control step; and
a processing step of performing processing on a basis of the displacement information complemented by the processing of the complementing step, wherein
in processing of the complementing step, in a case where a state in which quality of the transmission path is a predetermined quality continues for a predetermined time or more, complementation is performed by changing the displacement information received under the control of the reception control step to displacement information indicating displacement of the operation unit to an initial position.

15. A program for causing a computer to function as an information processing apparatus including:
a reception control unit that controls reception of displacement information that is transmitted from another information processing apparatus via a transmission path and indicates displacement of an operation unit that is displaced in accordance with an operation of a user, and presents a force sensation to the user;
a complementing unit that complements the displacement information received under control of the reception control unit; and
a processing unit that performs processing on a basis of the displacement information complemented by the complementing unit, wherein
in a case where a state in which quality of the transmission path is a predetermined quality continues for a predetermined time or more, the complementing unit performs complementation by changing the displacement information received under the control of the reception control unit to displacement information indicating displacement of the operation unit to an initial position.

16. An information processing apparatus comprising:
a communication control unit that performs control such that position information that indicates a position of an operation unit that is displaced according to an operation of a user and presents a force sensation to the user is transmitted to another first information processing apparatus via a first transmission path; and
a control unit that controls presentation of the force sensation by the operation unit on a basis of quality of the first transmission path and quality of a second transmission path between the another first information processing apparatus and another second information processing apparatus, wherein
the another first information processing apparatus transmits displacement information indicating displacement generated on a basis of the position information to the another second information processing apparatus via the second transmission path.

17. The information processing apparatus according to claim 16, wherein
the communication control unit also controls reception of quality information indicating quality of the second transmission path transmitted from the another first information processing apparatus via the first transmission path, and
the control unit controls the presentation of the force sensation on a basis of the quality of the first transmission path and the quality information received under the control of the communication control unit.

18. The information processing apparatus according to claim 16, further comprising
an estimation unit that estimates quality of the first transmission path, wherein
the control unit controls the presentation of the force sensation on a basis of the quality of the first transmission path and the quality of the second transmission path estimated by the estimation unit.

19. An information processing method in which
an information processing apparatus includes:
a communication control step of performing control such that position information that indicates a position of an operation unit that is displaced according to an operation of a user and presents a force sensation to the user is transmitted to another first information processing apparatus via a first transmission path; and
a control step of controlling presentation of the force sensation by the operation unit on a basis of quality of the first transmission path and quality of a second transmission path between the another first information processing apparatus and another second information processing apparatus, wherein
the another first information processing apparatus transmits displacement information indicating displacement generated on a basis of the position information to the another second information processing apparatus via the second transmission path.

20. A program for causing a computer to function as an information processing apparatus including:
a communication control unit that performs control such that position information that indicates a position of an operation unit that is displaced according to an operation of a user and presents a force sensation to the user is transmitted to another first information processing apparatus via a first transmission path; and
a control unit that controls presentation of the force sensation by the operation unit on a basis of quality of the first transmission path and quality of a second transmission path between the another first information processing apparatus and another second information processing apparatus, wherein
the another first information processing apparatus transmits displacement information indicating displacement generated on a basis of the position information to the another second information processing apparatus via the second transmission path.
